(19) United States
(12) Patent Application Publication
(10) Pub. No.: US 2025/0367854 A1
(43) Pub. Date: Dec. 4, 2025

(54) METHOD FOR PROVIDING A SIDE OF A CERAMIC UNIT WITH DECOR

(71) Applicant: DAL-TILE, LLC, Dallas, TX (US)

(72) Inventor: Rahul PATKI, Dallas, TX (US)

(21) Appl. No.: 18/875,055

(22) PCT Filed: Jun. 7, 2023
(86) PCT No.: PCT/IB2023/055871

§ 371 Date: Jan. 10, 2025

Related U.S. Application Data
(60) Provisional application No. 63/352,961, filed on Jun. 16, 2022.

(51) Int. Cl. B28B 11/00; B28B 11/04; B41M 5/00

(52) U.S. Cl. CPC B28B 11/001; B28B 11/048; B41M 5/0047; B41M 5/007

(57) ABSTRACT

A method for providing one or more sides or edges of a ceramic unit with decor may include the step of providing the ceramic unit. The ceramic unit may be made of a ceramic material and may include decor disposed on a main surface of the ceramic unit. The method may also include the step of acquiring an image of at least a portion of the decor disposed on the main surface of the ceramic unit. The method may also include the step of deriving decor for a side of the ceramic unit from the image. The method may also include the step of providing the decor on the side of the ceramic unit.

The present disclosure relates to methods for providing a ceramic unit of manufacture, for example, a slab or tile made of a ceramic material, and ceramic unit of manufacture, for example, a slab or tile made of a ceramic material according to the methods disclosed herein. In particular, the present disclosure relates to a method for providing one or more sides or edges of the ceramic unit of manufacture with decor.

A ceramic unit of manufacture, also referred to as a ceramic “unit,” comprises a base layer or “body” made of a ceramic material. Examples of ceramic units include a ceramic slab, such as may be used as a counter-top, or a ceramic tile, such as may be used on floor and/or wall surfaces. The ceramic unit further comprises decor and a glaze applied to a main surface of the ceramic unit. For example, one or more ceramic pigments may be digitally printed on the main surface to achieve the decor and at least one glaze layer may cover the decor. The base layer having the decor and glaze applied thereto are subjected to a firing treatment where high temperatures, for example around 1200° C., consolidating the base layer, and fix the ceramic pigments and glaze to the base layer, and solidify the ceramic pigments and glaze.

The decor is often applied to the ceramic unit of manufacture to imitate a desired theme or pattern, for instance, to imitate wood, stone, or cement. For example, where the ceramic unit of manufacture is a slab, common decors imitate stone such as granite or marble.

Only the main surface of the ceramic slab or tile includes the decor. As such, where the ceramic unit of manufacture is used in an application where a side or edge is intended to be visible, the side also need to be provided with decor. For instance, where a ceramic slab is intended for use as a countertop, the ceramic slab may be cut to size and rectified (e.g., squared), leaving sides where the base layer of ceramic material is exposed.

In the art, there are several general ways in which to provide decor on the sides or edges of a ceramic unit of manufacture. The first methodology involves applying decor with ceramic inks or colorants and a glaze to the side or edge. This methodology requires a second firing treatment to fix and solidify the glaze on the side or edge, and is therefore complex and expensive. A second methodology provides for spray painting the side or edge with one or more layers of paint. However, such applications of paint cannot be printed to accurately replicate the decor on the main surface, but can only make solid color decor, or dotted decor. Moreover, every layer of paint needs to be dried in a drying chamber for a prolonged period of time, so that the process is also time consuming, inefficient and generates substantial volatile organic compounds (VOC) s. Both of these technologies do not provide a decor on the edge that matches the one on the main decor.

Another methodology involves forming decor that extends through the body of the ceramic material, for instance, such that when the ceramic unit is cut, the decor extending through the thickness is made visible along the sides and edges.

As an example, US 2019/0009430 relates to the manufacture of ceramic products by a method that includes forming a ceramic product from a mixture that includes differently-colored ceramic powders. When formed into the ceramic product, the various ceramic materials yield various decor that extends through the thickness of the ceramic product, for example, into the body of ceramic material that forms the ceramic product. However, attempts to provide decor within the body of ceramic material suffer from several shortcomings.

For instance, WO 2021/250586 and WO2021/250587 relate to the production of a ceramic slab by a similar process, and to the resultant ceramic slab. WO 2021/250586 and WO2021/250587 recognize that ceramic slabs formed by depositing a ceramic layer into a soft ceramic material as the ceramic material moves along the plane in which the ceramic layer is deposited yields a decor exhibiting multiple visible “veins” all having a similar inclination, and thus giving the ceramic slab an unnatural appearance. Although WO 2021/250586 and WO2021/250587 propose improvements to the appearance of the decor within the body of the ceramic material, the provision of decor within the body of the ceramic material requires specialized equipment, adds unnecessary complexity and expense to the manufacturing process, and, at best, are limited in the decor that can be provided. WO 2016/113652 discloses a programable robot capable of digging and filling voids to form veins within a mold containing a ceramic mixture. This process for producing ceramic slabs is slow and, moreover, digging void spaces to create the veins can lead to inhomogeneities within the slab and subsequent defects or cracks in the ceramic slab. Moreover this technology is limited in the dimensions of the veins that can be produces and, accordingly, has the additional drawback that it is limited in the decor possibilities, in addition to being slow, complex, and expensive.

As such, there is a need for improved methods for providing a ceramic unit of manufacture, more particularly, improved methods for providing decor on one or more sides or edges of a ceramic slab or ceramic tile, which would solve one or more of the problems arising in the state of the art.

### SUMMARY

In some aspects disclosed herein is a method for providing one or more sides or edges of a ceramic unit with decor. The method may comprise providing the ceramic unit. The ceramic unit may be made of a ceramic material and may comprise decor disposed on a main surface of the ceramic unit. The method may also comprise acquiring an image of at least a portion of the decor disposed on the main surface of the ceramic unit. The method may also comprise deriving decor for a side of the ceramic unit from the image. The method may also comprise providing the decor on the side of the ceramic unit.

Additionally or alternatively, in some aspects disclosed herein is a ceramic unit obtained by the methods disclosed herein.

Additionally or alternatively, in some aspects disclosed herein is a machine-learning model. The machine-learning model may be configured to receive an image of at least a portion of decor disposed on a main surface of a ceramic unit, to evaluate the image, and to determine the decor for a side of the ceramic unit based upon the evaluation of the image.

Additionally or alternatively, in some aspects disclosed herein is a method of training a machine-learning model. The machine-learning model may be configured to receive an image of at least a portion of the decor disposed on the main surface of a ceramic unit, to evaluate the image and, to determine the decor for a side of the ceramic unit based upon the evaluation of the image. The method may comprise processing training data.

Additionally or alternatively, in some aspects disclosed herein is a ceramic unit comprising a ceramic material having a main surface with decor and a side having a decor that is inkjet-printed. The decor on the side may exhibit a high degree of continuity with respect to the main surface. For example, the side may have design features that appear to be continuous between the main surface and the side. Additionally or alternatively, the decor on the side comprises cured ink.

Additionally or alternatively, in some aspects disclosed herein is a set of ceramic units comprising at least a first ceramic unit and a second ceramic unit. Each of the first ceramic unit and the second ceramic unit may have a respective decor on its main surface. The first ceramic unit may comprise a decor on at least one side. The decor on the side of the first ceramic unit may be based on at least a portion of the decor on the main surface of the second ceramic unit.

Additionally or alternatively, in some aspects disclosed herein is a method for providing one or more sides or edges of a ceramic unit with decor. The method may comprise providing the ceramic unit. The ceramic unit may be made of a ceramic material and may comprise decor disposed on a main surface of the ceramic unit. The method may also comprise acquiring a first master file associated with the decor to be printed on said side. The method may also comprise evaluating the ceramic unit, for example scanning at least a portion of the decor disposed on the main surface and/or measuring the dimension of the ceramic unit and/or the color coordinates of the at least a portion of the decor disposed on the main surface. The method may also comprise deriving at least one correction factor from said evaluation. The method may also comprise correcting the master file on the basis of said correction factor. The method may also comprise providing the decor on the side of the ceramic unit based on the corrected master file.

These and other features will be more clearly understood from the following detailed description taken in conjunction with the accompanying drawings and claims.

### BRIEF DESCRIPTION OF THE DRAWINGS

For a more complete understanding of the present disclosure and the advantages thereof, reference is now made to the following brief description, taken in connection with the accompanying drawings and detailed description:

FIG. 1 shows a perspective view of the ceramic unit according to the disclosed subject matter;

FIG. 2 shows a perspective view of the ceramic unit of FIG. 1 with an exploded view of the layers on top of the side;

FIG. 3 shows a perspective view of a ceramic unit having decor disposed on a main surface thereof, and a first possibility for acquiring the image of decor disposed on the ceramic unit;

FIG. 4 shows a perspective view of a ceramic unit having decor disposed on a main surface thereof, and a first possibility for acquiring the image of decor disposed on the ceramic unit;

FIG. 5 shows a top view of a ceramic unit having decor disposed on a main surface thereof, and the derivation of decor for a side thereof according to the first preferred embodiment;

FIG. 6 shows a perspective view of the ceramic unit of FIG. 5, having decor disposed on a side thereof according to the first preferred embodiment;

FIG. 7 shows a tope view of a ceramic unit having decor disposed on a main surface thereof, and the derivation of decor for a side thereof according to the second preferred embodiment;

FIG. 8 is a schematic representation of a computing system in which a machine-learning model, such as the machine-learning model according to the second preferred embodiment, may be used;

FIG. 9 is a schematic representation of a machine-learning model;

FIG. 10 shows a top view of a ceramic unit having decor disposed on a main surface thereof, and the derivation of decor for a side thereof according to the third preferred embodiment;

FIG. 11 shows a perspective view of the ceramic unit of FIG. 10, having decor disposed on a side thereof according to the third preferred embodiment;

FIG. 12 is a schematic view of a portion of the disclosed method of providing decor on the side of a ceramic unit by printing with a curable ink;

FIG. 13 is an enlarged schematic view of the printer in FIG. 12; and

FIG. 14 is a schematic view of a portion of the disclosed method of providing decor on the side of a ceramic unit by printing with a curable ink, in accordance with the disclosed subject matter.

### DETAILED DESCRIPTION OF THE EMBODIMENTS

To facilitate an understanding of the principles and features of the various embodiments of the disclosed subject matter, various illustrative embodiments are explained below. Although certain embodiments of the disclosed subject matter are explained in detail, it is to be understood that other embodiments are contemplated. Accordingly, it is not intended that the disclosed subject matter is limited in scope to the details of any particular construction and/or arrangement of components set forth in the following description or examples. The disclosed subject matter is capable of other embodiments and of being practiced or carried out in various ways. Also, in describing the disclosed embodiments, specific terminology will be resorted to for the sake of clarity.

In the drawings and description that follow, like parts are typically marked throughout the specification and drawings with the same reference numerals, respectively. The drawing figures are not necessarily to scale. Certain features of the disclosed subject matter may be shown exaggerated in scale or in somewhat schematic form and some details of conventional elements may not be shown in the interest of clarity and conciseness.

Also, as used in the specification and the appended claims, the singular forms “a,” “an” and “the” include plural references unless the context clearly dictates otherwise. For example, reference to “a” component also includes a plurality of components. References to a composition containing “a” constituent includes other constituents in addition to the named constituent. In other words, the terms “a,” “an,” and “the” do not denote a limitation of quantity, but rather denote the presence of “at least one” of the referenced item. As used herein, the term “and/or” may mean “and,” it may mean “or,” it may mean “exclusive-or,” it may mean “one,” it may mean “some, but not all,” it may mean “neither,” and/or it may mean “both.” The term “or” is intended to mean an inclusive “or.”

Also, in the disclosed embodiments, various terminology will be utilized for the sake of clarity. It is intended that each term contemplates its broadest meaning as understood by those skilled in the art and includes all technical equivalents which operate in a similar manner to accomplish a similar purpose. It is to be understood that embodiments of the disclosed subject matter may be practiced without these specific details. References to “one embodiment,” “an embodiment,” “example embodiment,” “some embodiments,” “certain embodiments,” “various embodiments,” and the like, indicate that the embodiment(s) of the disclosed technology so-described may include a particular feature, structure, or characteristic, but not every embodiment necessarily includes the particular feature, structure, or characteristic. Further, repeated use of the phrase “in one embodiment” does not necessarily refer to the same embodiment, although it may.

The presently disclosed subject matter generally relates to methods for manufacturing a ceramic unit, in particular a ceramic slab or a ceramic tile which, in accordance with one or more of the embodiments, provides solutions to one or more of the problems arising in the state of the art.

Within the context of the present disclosure, the terms “ceramic unit of manufacture” and “ceramic unit” refer to a structure formed from a ceramic material. For example, the ceramic unit may comprise at least about 70% of a ceramic material by weight of the ceramic unit, additionally or alternatively, at least about 80% of a ceramic material, additionally or alternatively, at least about 90% of a ceramic material, additionally or alternatively, at least about 95% of a ceramic material. The term “ceramic material” refers to a material obtained by sintering, at a high temperature, a mineral raw material, for example, a clay, feldspar, calcium carbonate, a metal oxide, a silica, the like, or combinations thereof. In various embodiments, the ceramic material can be, for example, porcelain, earthenware, clay ceramic, red body tile, monoporosa, single fired ceramic, clinker, or the like. In some aspects, the structure formed by the ceramic material may be referred to as the “base layer” or the “body” of the ceramic unit.

In some embodiments, the ceramic material can be classified on the basis of the method by which the ceramic material is formed, for example, extrusion or semi-dry pressing, and/or on the basis of water absorption, as measured according to EN ISO 10545. In an embodiment, the ceramic material may be characterized as exhibiting a water absorption less than 0.5%, as measured according to EN ISO 10545. For example, in a preferred embodiment the ceramic material may be classified, according to EN 14411, in Group BIa, such as porcelain material. In another embodiment, the ceramic material may be characterized as exhibiting a water absorption between 0.5% and 3%, as measured according to EN ISO 10545. For example, in a preferred embodiment the ceramic material may be classified, according to EN 14411, in Group BIb. In other embodiments, the ceramic material may be classified in another group, as suitable.

In some embodiments, the ceramic unit may be characterized as a ceramic slab and/or a ceramic tile. References to a “ceramic slab” or a “ceramic tile” may generally, although not necessarily, denote various dimensions, sizes, formats, or intended uses. For instance, the term “ceramic tile” generally refers to a ceramic substrate having a relatively small format and intended for use on a floor and/or wall. The term “ceramic slab” generally refers to ceramic substrate having a relatively large format and intended for use, for example, as a countertop or in the furniture industry, such as a tabletop. A ceramic tile and/or a ceramic slab may be characterized with respect to a length, width, and/or thickness. For example, a ceramic tile may have a length and/or width from about 2 cm to about 90 cm and a thickness from about 2 mm to about 20 mm, preferably from about 6 mm to about 12 mm, whereas a ceramic slab may have a length and/or width of at least 90 cm, preferably from about 120 cm to about 320 cm and a thickness from about 5 mm to about 20 mm, preferably from about 6 mm to about 12 mm. Nonetheless, a particular ceramic unit may be characterizable as both a ceramic slab and a ceramic tile. As such, characterization of a ceramic unit as ceramic slab is not intended to exclude the possibility that the ceramic unit is also characterizable as a ceramic tile.

Within the context of the present disclosure, the term “main surface” refers to a surface of the ceramic unit that generally extends perpendicular to the thickness of the ceramic unit and, generally, that is intended to be visible when ultimately installed. Generally, the main surface is defined by the length and width of the ceramic unit and constitutes a substantial portion of the visible surface area of the ceramic unit. Preferably, the main surface of the ceramic tile can comprise a decor, for example, a design scheme or pattern imitating a natural material, like wood, a stone such as marble, or any desired design. Although various examples of a suitable decor, for example, imitating natural materials like stone or wood, may be exemplified in one or more of the embodiments, the term “decor” should not be construed as limiting the disclosed and/or claimed subject matter to any particular design, pattern, theme, coloration, or the like. The decor on the main surface may be made using ceramic colors, preferably ceramic inks, for example comprising metal oxides. The decor of the main surface is preferably digitally printed using, for example, an inkjet printer.

In some embodiments, the ceramic unit comprises at least one glaze layer covering the main surface of the ceramic unit of the ceramic material. The term “glaze layer” refers to a vitreous coating. The main surface of the ceramic unit may comprise at least a background glaze provided below the decor. Preferably, the ceramic unit also comprises a transparent glaze on top of the decor.

Within the context of the present disclosure, the terms “side” and “edge” are used interchangeably and refer to a surface of the ceramic unit, whether straight and/or flat, rounded (e.g., convex), beveled and/or angled, or profiled (e.g., such as a bullnose or an ogee), that is generally defined by the thickness of the ceramic unit and one of the length and the width of the ceramic unit.

In some applications of a ceramic unit may be utilized such that one or more edges of the ceramic unit, for instance, a ceramic slab, are visible. However, only the main surface of the ceramic slab or tile includes the decor. As such, where the ceramic unit is used in an application where one or more edges are intended to be visible, those edges should include decor. For instance, where a ceramic slab is intended for use as a countertop, the ceramic slab may be cut to size and rectified (e.g., squared), leaving sides where the base layer of the ceramic unit is exposed.

However, previous attempts to provide decor on the sides of a ceramic unit, for instance, a ceramic slab or ceramic tile, have yielded unsuitable results. Particularly, previous compositions used to provide decor on one or more edges are unsuitable to yield a high-quality finish that match the decor (with respect to both color and design) on the main surface. For instance, the use of paints only allows for the application of solid or dotted decor schemes, but cannot be used to provide designs imitating naturally-occurring colors or textures, such as wood or stone. Also, the use of ceramic inks or colorants to provide decor on one or more sides requires a second firing of the ceramic unit, thereby rendering this approach both slow and expensive and, moreover, unsuitable for use in an aftermarket setting, such as where a ceramic slab or tile must be cut after leaving a manufacturer facility (e.g., by an installer). Moreover, even if the art did provide a suitable composition for decorating one or more sides of a ceramic unit, the art does not provide for an approach that allows for matching between the decor on the main surface of a ceramic unit and one or more sides thereof.

### Method of Providing Side Décor

In a first independent aspect, the presently disclosed subject matter, which solves one or more of the problems arising in the state of the art, generally relates to a method for providing one or more sides or edges of the ceramic unit with decor. In some embodiments, the method generally comprises the steps of: providing a ceramic unit made of a ceramic material and comprising decor disposed on a main surface of the ceramic unit; acquiring an image of at least a portion of the decor disposed on the main surface of the ceramic unit; deriving decor for a side of the ceramic unit from the image; providing the decor on the side.

### Providing the Ceramic Unit

In some embodiments, the step of providing the ceramic unit generally comprises obtaining ceramic unit made from a suitable ceramic material, preferably, a porcelain. The ceramic unit comprises decor on the main surface thereof. The ceramic unit may be formed according to any suitable methodology known in the art, for example, generally including applying one or more pigments and glazes to the ceramic material and firing the ceramic material to form the ceramic unit. In the preferred embodiment the pigment and glazes and the ceramic material are fired together in a single firing step.

### Acquiring an Image of Decor Disposed on the Ceramic Unit

The step of acquiring the image may be performed according to several possibilities that can be performed either alone or in combination each other. Two preferred possibilities are described below.

In a first of said possibilities, the step of acquiring the image may comprise scanning at least a portion of the decor disposed on the main surface. For example, in various embodiments, all or substantially all of the main surface may be scanned or, alternatively, only a portion of the main surface may be scanned. For example, only a portion of the main surface corresponding to the information required to derive the decor for the side may be scanned, for instance, the portion of the ceramic unit as will be used and a portion of the ceramic unit adjacent to the portion of the ceramic unit that will be used. In embodiments where the step of acquiring the image comprises scanning at least a portion of the decor disposed on the main surface, the step of cutting the ceramic unit may be performed after the image has been acquired.

In a second of said possibilities, the step of acquiring the image may comprise acquiring a master file associated with the decor disposed on the main surface. The master file may be an image or other data upon which the decor disposed on the main surface is based, for instance, used to create the decor disposed on the main surface. Additionally or alternatively, the master file may be an image or other data upon which decor for a side may be based, and which may be particularly associated with the decor disposed on the main surface. In embodiments where the step of acquiring the image comprises acquiring a master file, the method may further comprise determining a correction factor for the ceramic unit. For instance, during the manufacture of the ceramic unit the decor is applied to the ceramic material and the ceramic material with the decor disposed thereon is fired to form the ceramic unit. During the firing of the ceramic material, the ceramic material may shrink or contract such that the decor applied to the main surface of the ceramic material also shrinks or contracts, for example, such as a shrinkage or contraction of from about 5% to about 10%, or of about 7%. The correction factor may be determined by measuring the dimensions of the ceramic unit, after firing, and/or by measuring the dimensions of various markings or features within the decor and comparing the measurements to the corresponding dimensions before firing, for example, the dimensions of the ceramic material before firing or the dimensions of markings or features within the decor. The correction factor may be applied to the master file, for example, to scale the master file or otherwise correct the master file such that the master file accurately corresponds to the decor on the main surface of the ceramic unit. Additionally or alternatively, the color and/or tonality (e.g., color coordinates) present on the main surface may be detected, for example, after firing, and compared to the colors and/or tonality indicated in the master file such that the colors and/or tonality indicated in the master file may be corrected or adjusted to match the colors and/or tonality present in the decor on the main surface of the ceramic unit.

### Deriving Decor for a Side of the Ceramic Unit From the Image

In a first preferred embodiment, the step of deriving decor for a side of the ceramic unit from the image comprises identifying a first portion of the image corresponding to a portion of the ceramic unit that will be used (e.g., installed, in an end-application) and, also, identifying a second portion of the image corresponding to a portion of the ceramic unit adjacent to the portion of the ceramic unit that will be used. For example, the second portion of the image may be adjacent to the first portion of the image. More particularly, the second portion of the image may be adjacent to the first portion of the image at the side that is to be provided with the decor (e.g., when the ceramic unit is cut).

In various embodiments, the first portion of the image may be identified so as to correspond to any suitable size and/or format, for example, such that the portion of the ceramic unit that will ultimately result from the disclosed method will have a desired size and/or format. Additionally, the first portion of the image may be identified based upon various additional consideration, for example, so as to include and/or exclude certain features of the decor, or so as to maximize efficiency as to usage of the ceramic unit.

The step identifying the first portion of the image corresponding to the portion of the ceramic unit that will be used may include identifying one or more markers within the decor on the first portion of the image. For instance, the marker may be a feature or combination of features on the surface of the ceramic unit that allows for a point or location on the ceramic unit and/or the orientation of the ceramic unit to be determined. In some embodiments, the marker comprises a feature or combination of features within the decor, for example, a features or combination of features that appear to be part of the decor, such as a particular grain pattern within a wood-look decor or a particular vein or combination of veins within a stone-look decor, such as a marble decor. In some embodiments, the decor on the main surface of the may be created so as to include one or more markers, for example, which may not be perceivable to the human eye, but are capable of being identified when imaged, such as by suitably-configured software. Additionally or alternatively, in some embodiments, the marker comprises an invisible marker, for example, that is invisible under normal conditions but can be rendered visible under certain conditions, such as under particular lighting conditions.

In the first preferred embodiment, the decor for the side is based upon the second portion of the image. For example, the decor for the side may be the decor in the second portion of the image. Alternatively, the decor for the side may comprise a portion of the decor in the second portion of the image, or an adjustment, skewing, or other alteration of the decor in the second portion of the image. In the first preferred embodiment, the use of the second portion of the image to provide the decor for the side yields side decor of significantly better quality than provided for in the art. For instance, because significant features within the first portion of the image may extend into the second portion of the image, the use of the second portion of the image as the basis for the decor for the side allows for the continuity of such features (e.g., a vein or pattern) between the decor on the main surface and the side.

Alternatively, in a second preferred embodiment, the step of deriving decor for a side of the ceramic unit from the image comprises evaluating the image and, also, determining the decor for the side based upon the evaluation of the image. Preferably, the step of evaluating the image is performed via a suitable machine-learning model. For example, in embodiments where the ceramic unit is cut after acquiring the image of the decor on the main surface, the machine-learning model may be configured to identify a portion of the ceramic unit a first portion of the image corresponding to a portion of the ceramic unit that will be used. The machine-learning model may also be configured to identify a feature within the image and/or within the first portion of image corresponding to a feature within the decor on the main surface. For example, the machine-learning model may include certain features and/or omit certain features in the evaluation step.

Also, preferably, the step of determining the decor for the side based upon the evaluation of the image is also performed via the machine-learning model. For example, the machine-learning model may also be configured to predict a related feature based upon the feature identified within the image. For example, relatively more significant features, such as a vein within decor imitating a natural stone like marble, may be identified by the machine-learning model and a corresponding feature may be provided in the decor for the side, such as an extension of the vein.

In the second preferred embodiment, the decor for the side is based upon the operation of the machine-learning model. In various embodiments, the side decor, as determined by the machine-learning model, may be effective to imitated any suitable decor, for example, a naturally-occurring design or pattern such as a wood or a stone like granite or marble. In the second preferred embodiment, the use of the machine-learning model to provide the decor for the side also yields side decor of significantly better quality than provided for in the art. For instance, because the machine-learning model can identify certain features within the decor on the main surface and predict corresponding features within the decor on the side, the use of the machine-learning model allows for continuity of features (e.g., a vein or pattern) between the decor on the main surface and the side.

Alternatively, in a third preferred embodiment, the step of deriving decor for a side of the ceramic unit from the image comprises identifying a first portion of the image corresponding to a portion of the ceramic unit that will be used (e.g., installed, in an end-application) and, also, identifying at least a part of the first portion of the image corresponding to a portion of the ceramic along the side at which the decor is to be provided.

In the third preferred embodiment, the decor for the side is based upon the part of the first portion of the image. For example, the decor for the side may be a mirror-image the decor in the part of the first portion of the image, for instance, mirrored along the side. Alternatively, the decor for the side may comprise a portion of the decor in the part of the first portion of the image (e.g., mirrored along the cutting line), or an adjustment, skewing, or other alteration of the decor in the second portion of the image. In the third preferred embodiment, the use of the part of the first portion of the image to provide the decor for the side yields side decor of significantly better quality than provided for in the art. For instance, because the decor is obtained by mirroring the decor along the side at which the decor is to be provided, the use of the decor within the part of the first portion of the image as the basis for the decor for the side allows for the continuity of such features (e.g., a vein or pattern) between the decor on the main surface and the side.

### Providing Decor on the Side

In some embodiments, the method may include one or more steps, prior to providing the decor on the side, to prepare the ceramic unit to have decor applied thereto.

For instance, in some embodiments, the method may comprise the step of cutting the ceramic unit into one or more pieces having a suitable size for an intended utilization. In an embodiment, the step of cutting the ceramic unit can be performed prior to the step of acquiring the image of at least a portion of the decor disposed on the main surface of the ceramic unit. In some alternative embodiment, the step of cutting the ceramic unit can be performed after the step of acquiring the image of at least a portion of the decor disposed on the main surface of the ceramic unit. As will be disclosed herein, the suitability of performing the step of cutting the ceramic unit prior to or after the acquiring the image may depend upon the way in which the decor for the side is derived from the image.

For instance, in embodiments where the step of acquiring the image is carried out according to the first possibility (e.g., where the image is acquired by scanning) and where the step of deriving decor for a side of the ceramic unit from the image is carried out according to the first preferred embodiment, the step of cutting the ceramic unit is preferably performed after the image of at least a portion of the decor disposed on the main surface of the ceramic unit has been acquired.

Also for instance, in embodiments either where the step of acquiring the image is carried out according to the second possibility (e.g., where the image is acquired from a master file or other existing file) or where the step of deriving decor for a side of the ceramic unit from the image is carried out according to the first preferred embodiment, the step of cutting the ceramic unit is preferably performed after the image of at least a portion of the decor disposed on the main surface of the ceramic unit has been acquired.

In some embodiments, the step of cutting may be carried out according to the identification of the first portion of the image. For example, the ceramic unit may be cut (if not previously cut to size) such that, after cutting, the ceramic unit corresponds to the first portion of the image, that is, the portion of the ceramic intended for use and/or installation.

Additionally, in some embodiments, for example, in embodiments where the ceramic unit is cut after acquiring the image of the decor on the main surface, the cuts to the ceramic unit may be verified to ensure that the cuts are consistent with the identification of the first portion of the image, that is, the portion of the ceramic unit identified in the image for use and/or installation. In some embodiments, verifying the cuts may comprise reimaging, for example, re-scanning the ceramic unit after cutting and comparing the resulting image (a second image) with the earlier image to ensure that the ceramic unit was cut consistent with the identification of the first portion of the image.

The step of cutting can be performed either via a wet-cutting or a dry-cutting methodology. In case of wet cutting the method may further comprise the step of drying the cut pieces to remove the lubricant water or fluid. The drying steps for removing the lubricant water can be preferably performed by hot air. In a preferred embodiment, the step of cutting the ceramic unit may also comprise rectifying the ceramic unit, for example, squaring and/or straightening one or more sides of the ceramic unit, such as by grinding one or more sides or edges.

In some embodiments, prior to providing the decor on the side, the method may comprise the step of drying at least the side, for example via an infrared lamp, for instance, in addition to any drying following wet cutting and/or grinding. This drying step, prior to providing the decor on the side, may be effective to ensure that the side is completely dry at the time of performing the step providing the decor on the side. For instance, the porosity of the ceramic material forming the ceramic unit can absorb moisture present in the atmosphere thereby negatively affecting the adhesion between the decor (e.g., ink) and the ceramic material.

In some embodiments, the step of providing the decor on the side is preferably performed by printing with one or more inks, for example, a set of inks. In the preferred embodiment said step of printing is an inkjet printing step.

In the preferred embodiments the inks are curable inks and the step of providing the decor on the side further comprises curing the inks. The curable inks are preferably radiation-curable, for example UV radiation or electron beam (EB) radiation. The set of curable inks may preferably comprise acrylic-based inks, for example comprising a blend of different types of acrylate monomers and/or oligomers such as polyester acrylate, polyether acrylate, urethane acrylate, epoxy acrylate, or combinations thereof. Preferably the inks comprise a photo initiator, for example, to activate curing of the ink in presence of a predetermined dose of radiation. In an alternative embodiment, the step of providing the decor on the side comprises printing using one or more ceramic inks and firing the ceramic inks to form the decor.

In some embodiments, the ink may be printed in direct contact with the ceramic material. Generally, reference to the ink, after printing, being in direct contact with the ceramic material and, similarly, reference to the ink being printed in direct contact with the ceramic material, generally, within the context of the present application, means that there is not any layer between the decor and the ceramic material. More particularly, reference to the direct contact means that the side of the ceramic unit is free from any basecoat, for example, between the decor and the ceramic material. For example, in methods disclosed herein may be free from any step, prior to providing the decor, in which a substance is applied to the side of the ceramic unit. Reference to direct contact is not to be meant to indicate that the decor is printed with a direct contact printing technique, like for example offset printing; rather, the printing can be performed via contactless printing techniques. The inks, after curing, show very good adhesion with the ceramic material so that there is no need to add any intermediate layer between the substrate and the ink.

Alternatively, in some embodiment, the ink may be printed over a basecoat. For example, in some embodiments, the methods may further comprise providing a basecoat prior to printing the inks. In the preferred embodiment wherein the ink is a curable ink, the basecoat may be a UV basecoat, preferably polyurethane or acrylic based, provided before printing the decor. In the alternative embodiment wherein the ink is a ceramic ink, the basecoat can be a glaze. In various embodiments, the basecoat can be clear or can be colored, for instance, to provide a background for the decor. For example, the basecoat may be preferably used to provide a background when the color of the base layer is darker than the color of the decor. For instance, where the background is generally darker than the decor, it may be preferable for the decor to be printed directly, such as without a colored basecoat or, alternatively, with a clear basecoat. Likewise, where background is generally lighter than decor, it may be preferable for the decor to be printed upon a colored (e.g., not clear) background.

In some embodiments, the set of inks is a “CMYK” ink set, for example, comprising inks of Cyan, Magenta, Yellow and “Key” (that is, black) colors. Generally, the CMYK set of inks provides a wide range of potential colors, for example, such that the CMYK set of inks may be suitable for printing different decors independent from the background. In some embodiments, the CMYK set of inks may be printed directly onto the ceramic material of the base body, for instance without the need of any primer and or basecoat. The CMYK inks may be particularly effective where the ceramic material has a light color, for example white, grey, beige, and the shades thereof, and even more particularly when the ceramic material of the base body is porcelain. The CMYK inks may also be particularly effective where when the decor to be printed is composed of dark colors, for example, imitating dark woods, black marble, or dark stone. Generally, the CMYK inks may be preferred when the color of the ceramic material of the body is lighter than the colors composing the decor. Where this is the case, a relatively light color for the ceramic material may represent a good background for the relatively dark colors of the decor, for example, so that the color of the decor can sufficiently be developed.

Additionally or alternatively, in some embodiments, the set of inks can comprise one or more extra inks in addition to the CMYK inks or in place of one or more of the CMYK inks. For instance, one or more spot colors can be added to the CMYK set to further enlarge the range of potential colors. Additionally or alternatively, in some embodiments, spot colors can be substituted for one or more colors of the CMYK system. In this way, the range of potential colors may be narrower, but can be tailored to the decor to be printed, for instance, to reduce ink consumption.

For example, in some embodiments, the extra inks can preferably comprise white and/or yellow ink. More preferably, the extra ink may be printed directly onto the ceramic material of the base body without the need of any primer and or basecoat, and can be printed in order to create a background color for the decor formed mainly by the CMYK inks. The extra inks can also form part of the decor together with the CMYK inks. Moreover, in case of a yellow extra ink, the printer can be preferably configured to print two yellow inks, one being a part of the CMYK set and one forming the extra ink. The use of an extra ink along with the CMYK set may be particularly effective where the ceramic material has a dark color, for example brown, red or dark grey, and the shades thereof, and even more particularly when the ceramic material of the base body is red body clay. The use of an extra ink along with the CMYK set preferred embodiment may also be particularly effective when the decor to be printed is composed of light colors, for example light woods, white marble or white/beige stone. Generally, the use of an extra ink along with the CMYK set may be preferred when the color of the ceramic material of the body is darker than the colors composing the decor. Where this is the case, the extra inks can form a background covering the color of the ceramic material in order to help the development of the colors of the decor.

In a first embodiment of how an extra ink may be used along with the CMYK set to print the decor, the method may comprise the step of printing the one or more extra inks immediately before the step of printing the CMYK inks. In such an embodiment, the extra inks are printed in such a way to cover at least a portion, preferably all of the surface of the side, thereby forming a background for the decor. In some embodiments, the extra inks can be mixed together, after printing, in order to obtain the desired tonality or shades of the background. It is important to note that the extra ink may not be a basecoat, a tie coat or a primer. For instance, the extra ink may be an ink having the same chemical and physical characteristics of the CMYK inks, so that it provides the sole functions of covering the color of the ceramic material and aids the development of the colors of the decor. In this first way the extra inks can be printed with a separate printer that that for printing the extra CMYK inks, although the extra inks and the CMYK inks can also be printed with the same printer.

In some embodiments, the extra inks can be cured together with the CMYK inks. In some alternative embodiments, the extra inks are cured before curing the CMYK inks.

In a second embodiment of how an extra ink may be used along with the CMYK set to print the decor, the method may comprise the step of printing the one or more extra inks together with the CMYK inks. In this way the extra inks even if they are not printed to form a background are mixed with the CMYK to help the development of the colors of the decor.

In various additional or alternative embodiments, the set of inks can be formed of inks of any color. The color can be selected in such a way to be the best for performing the print of predetermined design colors. For instance, spotcolors may be used, for example, the reduce metamerism and/or to improve color matching between the decor on the main surface and the decor on the side. The use of various other color sets may be particularly efficient when a reduced quantity of differing decors is printed. The CMYK color set allows for a wide variety of colors to be obtainable with the inks and also increases the variety of the possible decors to be printed.

In some embodiments, preferably, the step of providing decor on the side comprises printing in a single-pass printing operation. Single-pass means that the printer comprises a stationary printing unit and that the piece to be printed, in the context of this disclosure, the ceramic unit, moves of a continuous movement below, or in front of, the printing unit. For instance, in particular, the printer may preferably comprise a plurality of printing units aligned along the advancing direction, with each printing unit configured to print one ink. A printing unit, also often called a bar or a beam, can comprise one or more printing heads. Each printing unit preferably is dedicated to a specific color. Thus, the colors are sequentially printed on the basis of the sequence of the printing unit in the advancing direction. In embodiment where an extra ink may be used along with the CMYK set to print the decor, the printing unit for printing the extra ink may be preferably disposed upstream with respect to the advancing direction.

In some embodiments, the step of printing (e.g., using an inkjet printer) the ink (e.g., the curable ink) may comprise jetting droplets of 12 picoliters (pl) or more. For example, the step of printing the ink can be performed via a printhead having nozzle of 60 micrometers (um) diameter. This can permit a decor layer having a thickness of between 6 to 25 μm to be printed. Moreover, the ink forming the decor is provided in a quantity of between 0.75 to 1.15 mg/square cm. This helps in forming a layer that is sufficiently thick to show good adhesion performances and mechanical, physical and chemical properties. In some embodiments, the decor may be printed with a resolution of 360 dpi.

In some embodiments, preferably, the printing units, can be disposed at an angle or can be configured to be tilted relative to a supporting frame of the printer, in such a way to correctly perform the print on the configuration of the side, especially when the latter is curved or inclined.

In some embodiments, the printer can also comprise a detecting means adapted to identify the incoming ceramic unit and/or the decor on the main surface thereof, in such a way to determine the correct decor to print on the side, for example, so that the decor on the side can be aligned with the corresponding decor on the main surface.

### Ink-Curing

The step of curing the curable ink may comprise exposing the curable ink or inks to a radiation, for example UV radiation or electron beam (EB) radiation. For example, in embodiments where the curable inks are UV-curable, the method comprises the step of exposing the ceramic unit, in particular the side thereof having the decor disposed thereon, to a UV lamp, for example a mercury lamp, a gallium lamp, or a LED-UV lamp. For curing the curable ink, a LED-UV lamp is preferred because the LED-UV emits radiation in a narrow wavelength of radiation and with high intensity, for examples, so as to quickly cure the inks. For example, the UV radiation can be in the UVA range of wavelengths from 315 nanometers (nm) to 400 nm. In some embodiments, for pigmented curable substances, like the inks, a longer wavelength may be preferred to cure the decor more deeply. The step of curing the curable ink is preferably performed immediately after the step of printing. In some embodiments, the step of curing the inks can also comprise a first, partial curing and a second, subsequent complete curing the inks. In some embodiments, radiation curing may be particularly advantageous compared to other curing mechanism because it provides for a fast and almost instantaneous curing.

In the case of a ceramic ink, firing involves firing the ceramic unit with the ink and, possibly, any base coat or protective coat in a kiln at a temperature above 500° C., for example above 600° C. The firing temperature can be below 900° C., for example below 800° C.

### Protective Coating

In some embodiments, the method may further comprise the step of providing a protective coat on top of the decor. The protective coat can be transparent or translucent. Also, the protective coat can be either glossy or matte. Generally, the protective coat may have a thickness that is greater than the thickness of the decor. The protective coat may be effective to provide mechanical, physical, and chemical resistance to the decorated side of the ceramic unit. In particular, protective coat may be effective to provide resistance against scratches and chemical attack. Additionally, the protective coat may improve the adhesion of the decor to the ceramic material.

In some embodiments, the protective coat is a curable protective coat, preferably a radiation-curable protective coat, for example UV radiation or electron beam (EB) radiation. The protective coat may preferably comprise an acrylic based resin, for example comprising a blend of different types of acrylate oligomers and/or monomers such as polyester acrylate, polyether acrylate, urethane acrylate, epoxy acrylate, or combinations thereof. Preferably the protective coat comprises a photo initiator to activate curing of the protective coat thereof in presence of a predetermined dose of radiation. In the alternative embodiment where the ink is a ceramic ink, the protective coat can be transparent or translucent glaze.

In some embodiments, the protective coat can comprise fillers like mineral particles, for example talc, calcium carbonate, aluminum oxide. The fillers may modify the aspect and/or the mechanical, physical and/or chemical performances of the protective coat. For example, the fillers can be the so-called flattening agent, which may reduce the glossiness of the protective coat.

In some embodiments, the step of providing the protective coat is a coating step, for example, where the protective coat is applied as a spray or via a roller. Alternatively, in some embodiments the step of providing the protective coat can be performed via operation of an inkjet printer.

Application by coating may permit application of a more viscous composition, such as when the protective coat comprises fillers. Moreover, application by coating may allow the formation of a relatively thicker layer of protective coat. As an alternative to inkjet printing, other digital printing techniques can be used like, for example valve jet printing. Valve jet printing allows printing more viscous inks and also providing a higher amount of inks to make a thicker protective coat, in comparison to inkjet printing.

The step of curing the protective coat may comprise exposing the protective coat to radiation, for example UV radiation or electron beam (EB) radiation. In an embodiment where the protective coat is UV-curable, the method comprises the step of exposing the ceramic unit, in particular the side thereof, to a UV lamp, for example a mercury lamp, a gallium lamp, or a LED-UV lamp. For curing the protective coat, a mercury lamp is preferred, in particular a mercury lamp that emit UVB radiations. For example, the UV radiation can be in the UVB range of wavelengths from 280 nm to 315 nm. In some embodiments, for a transparent curable substance, like the protective coat, a shorter wavelength may be preferred to cure the decor more deeply. The step of curing the protective coat is preferably performed immediately after the step of providing the protective coat. In some embodiments, the step of curing the inks is a first, partial curing and the step of curing the protective curing can also comprise a second, subsequent complete curing of the ink. In some embodiments, the method may further comprise finishing steps like sorting and/or packaging.

It is to be noted that, although the methods disclosed herein can be used to provide decor to any side or edge surface of a ceramic unit, the methods disclosed herein are particularly advantageously applied in applications where a ceramic unit is cut down from a size in which it was manufactured to achieve a particular size. That is, the methods disclosed herein are particularly advantageously employed to provide decor on a side of a ceramic unit that has been cut, rectified, and, optionally, ground. For instance, although decor can be provided on an original side of the ceramic unit (that is, a side originally present when the ceramic unit is manufactured) by way of the same methods as used to provide decor on the main surface, and in some instances, contemporaneous with the provision of decor on the main surface, when one or more side of a ceramic unit are cut, for example, to achieve a particularly, custom (e.g., non-standard) size, the methods for providing decor on the main surface are not viable, because such methods require a second firing of the ceramic unit.

In some embodiments, the methods disclosed herein can be performed outside of the manufacturing facility, such as by an installer. Additionally, the operations of the method can be performed in-line in the manufacturing facility of the ceramic unit. In particular the ceramic unit can be transported toward the between various operative stations for performing the above-mentioned steps by an automated transporter or conveyor that can, preferably, be the same for all the operations. In fact, an important advantage of using radiation-curable substances, is that the manufacturing line or equipment is definitely smaller than those needed for the standard method.

In a second independent aspect, the disclosed subject matter relates to a ceramic unit comprising a ceramic material having a main surface with decor and a side having a decor that exhibits a high degree of continuity with respect to the main surface (for example, the side having design features that appear to be continuous between the main surface and the side). For instance, the decor on the side may be provided by way of the method described with respect to the first aspect. The side comprises a cured, digitally printed decor in direct contact with the ceramic material. The ceramic unit according to the second aspect of the disclosed subject matter can comprise one or more of the features described with reference to the first aspect.

In a third independent aspect, the disclosed subject matter relates to a machine-learning model configured to receive an image of at least a portion of the decor disposed on the main surface of a ceramic unit, to evaluate the image and, also, to determine the decor for a side of the ceramic unit based upon the evaluation of the image. The machine-learning model according to the third aspect of the disclosed subject matter can comprise one or more of the features described with reference to the first aspect.

In a fourth independent aspect, the disclosed subject matter relates to a method of training a machine-learning model configured to receive an image of at least a portion of the decor disposed on the main surface of a ceramic unit, to evaluate the image and, also, to determine the decor for a side of the ceramic unit based upon the evaluation of the image, for example, the machine-learning model described with respect to the third aspect. The method comprising processing training data and, optionally, evaluating the machine-learning model to determine if an error exhibited by the trained machine-learning module is not acceptable.

In a fifth independent aspect, the disclosed subject matter relates to a ceramic unit comprising a ceramic material having a main surface with decor and a side having a decor that is inkjet-printed. The decor on the side exhibits a high degree of continuity with respect to the main surface. For example, the side may have design features that appear to be continuous between the main surface and the side. Additionally or alternatively, the decor on the side comprises cured ink.

In a sixth independent aspect, the disclosed subject matter relates to a set of ceramic units. The set of ceramic units comprises at least a first ceramic unit and a second ceramic unit. Each of the first ceramic unit and the second ceramic unit may have a respective decor on its main surface. The first ceramic unit may be, for example, a ceramic unit having the decor disposed on the side and ready for installation, for example, as may be prepared according to the methods disclosed herein. The second ceramic unit may be, for example, the ceramic unit used to prepare the first ceramic unit, for example, according to the methods disclosed herein. The first ceramic unit comprises a decor on at least one side. The decor on the side of the first ceramic unit is based on at least a portion of the decor on the main surface of the second ceramic unit. For example, the decor of the side may comprise a portion of the decor on the main surface of the second surface, or an adjustment, a skewing, or another alteration thereof. Additionally or alternatively, the decor of the side may be a mirror-image of a portion of the decor on the main surface of the second surface, or an adjustment, a skewing, or another alteration thereof.

In a seventh independent aspect, the disclosed subject matter relates to a method for providing one or more sides or edges of a ceramic unit with decor. The method may comprise providing the ceramic unit. The ceramic unit may be made of a ceramic material and may comprise decor disposed on a main surface of the ceramic unit. The method may also comprise acquiring a first master file associated with the decor to be printed on said side. The method may also comprise evaluating the ceramic unit. For example, the method may comprise scanning at least a portion of the decor disposed on the main surface, measuring the dimension of the ceramic unit, and/or determining the color coordinates of the at least a portion of the decor disposed on the main surface. The method may also comprise deriving at least one correction factor from said evaluation. For example, the correction factor may be based upon the scanning at least a portion of the decor disposed on the main surface, the measuring the dimension of the ceramic unit, and/or the determining the color coordinates of the at least a portion of the decor disposed on the main surface. The method may also comprise correcting the master file based on said correction factor. The method may also comprise providing the decor on the side of the ceramic unit based on the corrected master file.

It is to be noted that the disclosed subject matter can also relates to an equipment for performing the methods disclosed herein. This equipment can comprise one or more of the features described in relation to the other independent aspects of the disclosed subject matter.

### FIGURES

With the intention of better showing the characteristics of the disclosed subject matter, in the following, as an example without any limitative character, several preferred forms of embodiments are described with reference to the accompanying Figures that follow, where:

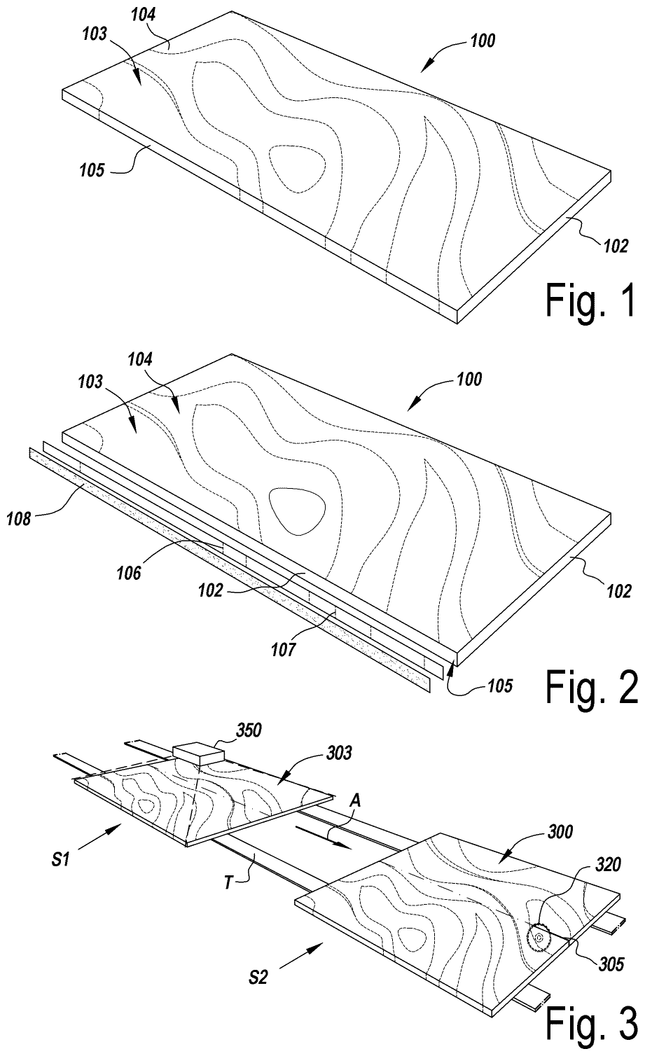

FIG. 1 shows a perspective view of the ceramic unit according to the disclosed subject matter;

FIG. 2 shows a perspective view of the ceramic unit of FIG. 1 with an exploded view of the layers on top of the side;

FIG. 3 shows a perspective view of a ceramic unit having decor disposed on a main surface thereof, and a first possibility for acquiring the image of decor disposed on the ceramic unit;

FIG. 4 shows a perspective view of a ceramic unit having decor disposed on a main surface thereof, and a first possibility for acquiring the image of decor disposed on the ceramic unit;

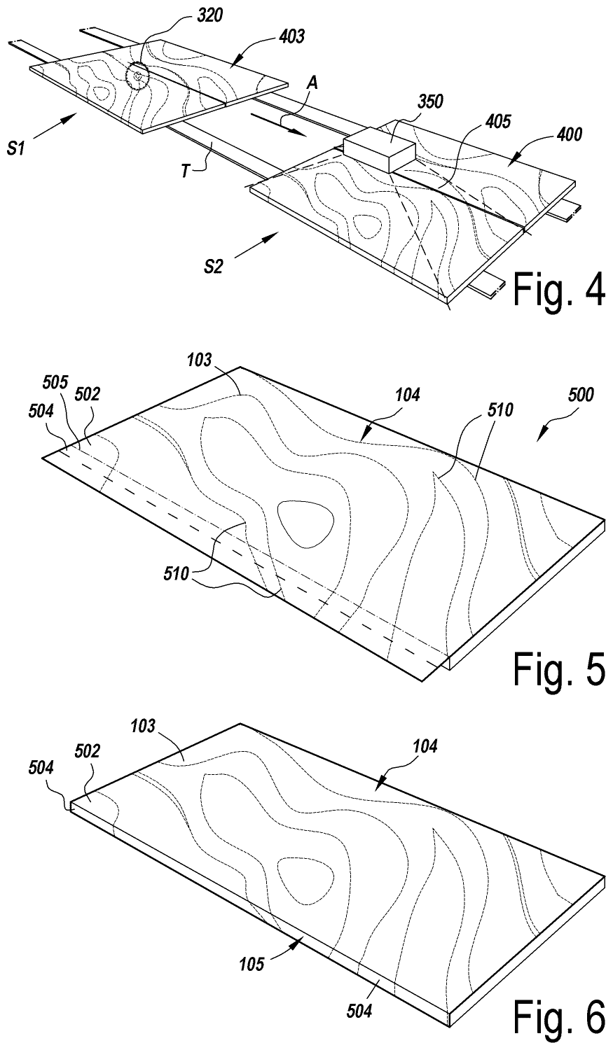

FIG. 5 shows a top view of a ceramic unit having decor disposed on a main surface thereof, and the derivation of decor for a side thereof according to the first preferred embodiment;

FIG. 6 shows a perspective view of the ceramic unit of FIG. 5, having decor disposed on a side thereof according to the first preferred embodiment;

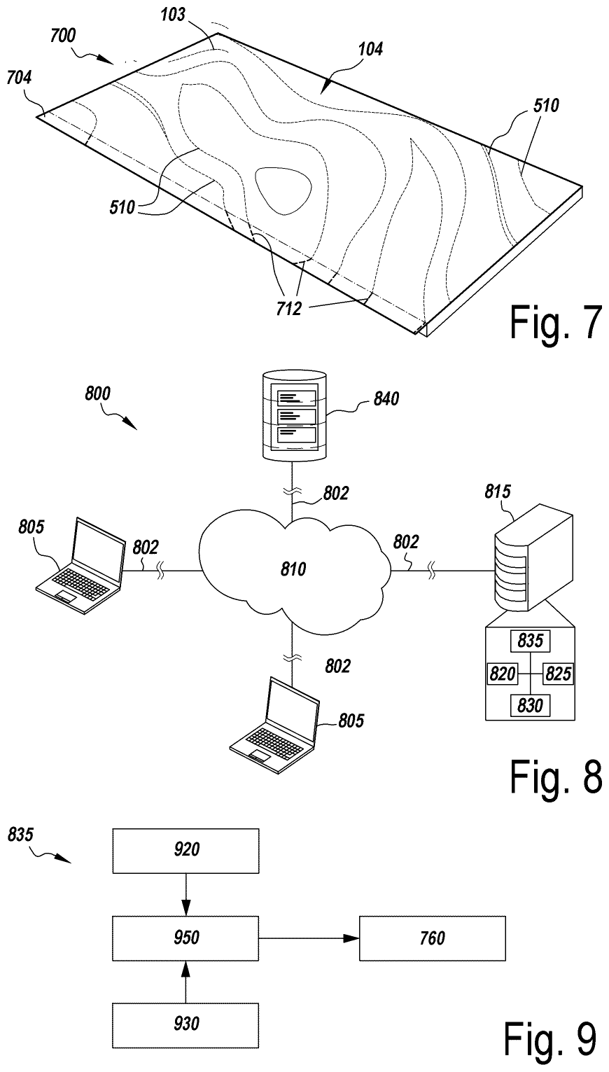

FIG. 7 shows a tope view of a ceramic unit having decor disposed on a main surface thereof, and the derivation of decor for a side thereof according to the second preferred embodiment;

FIG. 8 is a schematic representation of a computing system in which a machine-learning model, such as the machine-learning model according to the second preferred embodiment, may be used;

FIG. 9 is a schematic representation of a machine-learning model;

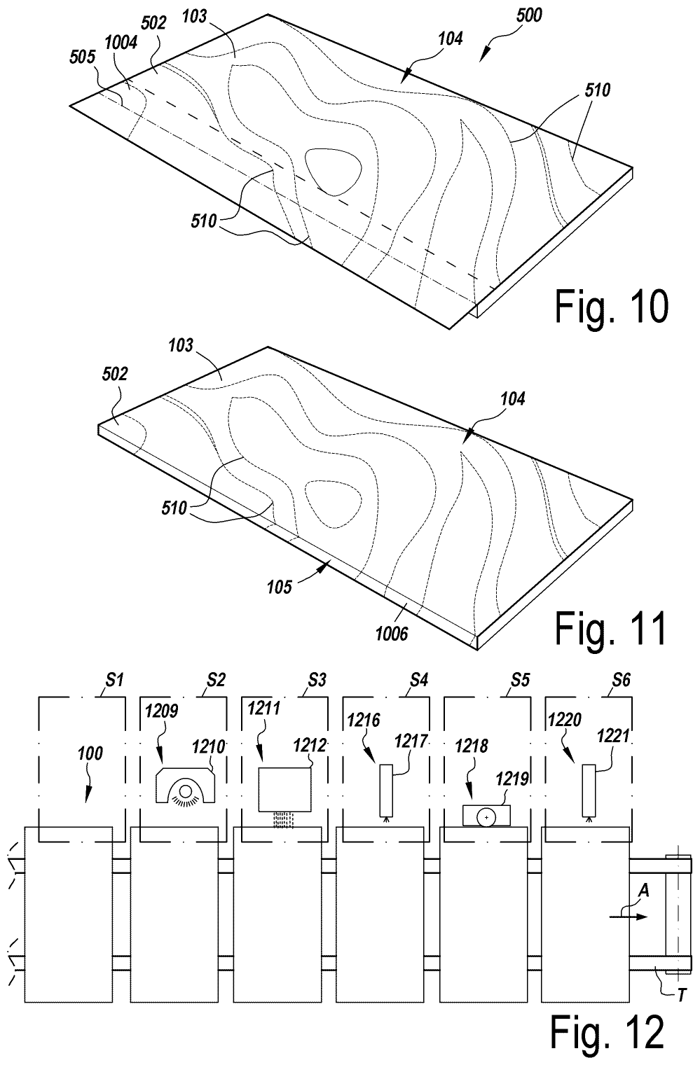

FIG. 10 shows a top view of a ceramic unit having decor disposed on a main surface thereof, and the derivation of decor for a side thereof according to the third preferred embodiment;

FIG. 11 shows a perspective view of the ceramic unit of FIG. 10, having decor disposed on a side thereof according to the third preferred embodiment;

FIG. 12 is a schematic view of a portion of the disclosed method of providing decor on the side of a ceramic unit by printing with a curable ink;

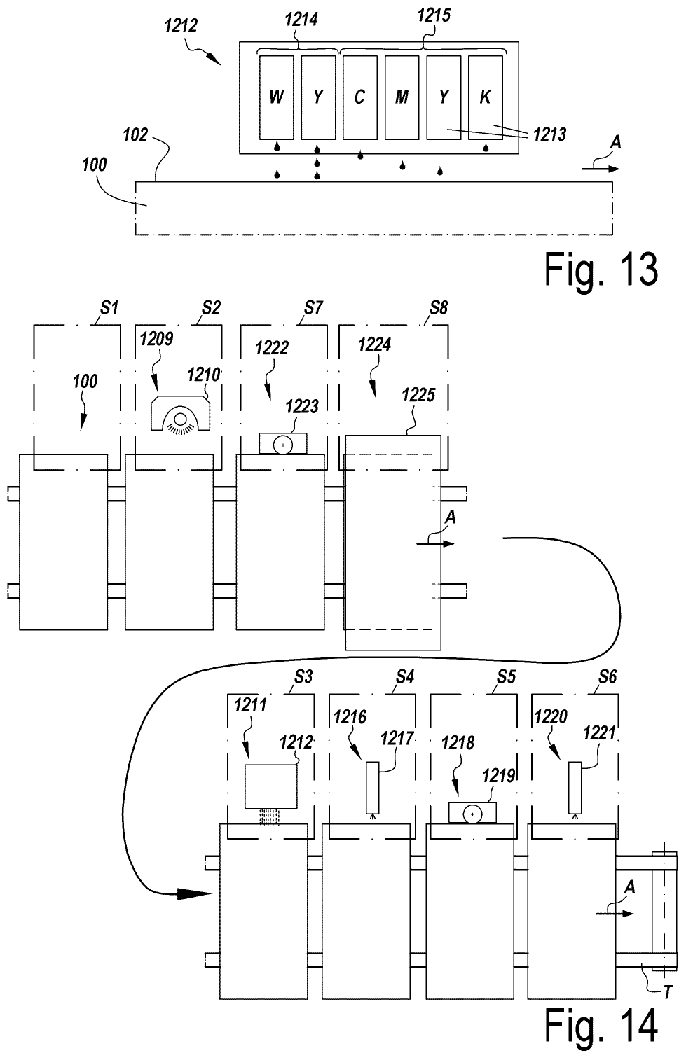

FIG. 13 is an enlarged schematic view of the printer in FIG. 12; and

FIG. 14 is a schematic view of a portion of the disclosed method of providing decor on the side of a ceramic unit by printing with a curable ink, in accordance with the disclosed subject matter.

### FIGS. 1 and 2

FIG. 1 shows a ceramic unit 100 comprising substrate made of a ceramic material 102. The ceramic material 102 is preferably porcelain, for example it shows a water absorption below 0.1 as measured according to EN ISO 10545. The ceramic material 102 comprises a main surface 103 provided with a decor 104 including a vitreous material, for instance, a glaze. Particularly, the main surface 103 includes one or more glaze layers disposed over the decor 104 which may be obtained by inkjet printing with ceramic inks.

The ceramic unit 100 further comprises at least one side 105 that comprises decor 106 that, matches, for example, exhibits continuity of one or more features present in, the decor 104 on the main surface 103 of the ceramic unit 100. As shown in FIG. 2, the ceramic unit 100 comprises a decorative layer 107 that forms the decor 106 and that is made of cured inks. It is to be noted that the decorative layer 107 may include various features so as to imitate any desired material, for example, a natural material like wood or a stone such as marble. In some embodiments, the inks are in direct contact with the ceramic material 102. The decorative layer 107 is obtained by digital inkjet printing, preferably with a resolution of 320 dpi. The decorative layer 107 may have a thickness between 6 and 25 μm.

On top of the decorative layer 107 is provided a protective coat 108. The protective coat 108 is transparent or translucent. Preferably, the protective coat 108 has a thickness that is higher than that of the decorative layer 107. The protective coat 108 can also comprise filler, like mineral particles (not shown). In particular, flattening agents like talc or calcium carbonate may be used to create a matte effect.

### FIGS. 3 and 4

FIGS. 3 and 4 illustrate two possibilities for the step of acquiring the image of decor disposed on the ceramic unit. In FIGS. 3 and 4, a ceramic unit is advanced through various steps on top of a transporter T. The transporter T, for example transporting belt, moves the ceramic unit in an advancing direction A.

Particularly, FIG. 3 illustrates the first of these possibilities, where the step of acquiring the image comprises scanning at least a portion of the decor disposed on the main surface 303 of a ceramic unit 300. In step S1 all, substantially all, or some portion of the main surface 303 of a ceramic unit 300 may be scanned via the operation of a scanner 350. Generally, the scanner 350 may be any suitable device capable of optically scanning the main surface 303 and producing a digital image representative of the main surface 303. For example, the scanner 350 may be sized to optically scan a ceramic unit of the types and dimensions disclosed herein. Also, the scanner may be capable of producing a digital image of sufficient quality as to enable the production of decor having the characteristics also disclosed herein.

Referring to step S2, scanning at least a portion of the decor disposed on the main surface 303 may also include identifying one or more markers 320 present within the decor. The marker(s) 320 may allow for a point or location on the ceramic unit and/or the orientation of the ceramic unit to be determined, for example, to enable a cut-line 305 to be located at a particular location on the ceramic unit 300. The marker 320 may comprise a feature or combination of features within the decor, for example, a features or combination of features that appear to be part of the decor, such as a particular grain pattern within a wood-look decor or a particular vein or combination of veins within a stone-look decor, such as a marble decor. The markers may not be perceivable to the human eye, but are capable of being identified when imaged, such as by the scanner 350. Additionally or alternatively, the marker 320 may comprise an invisible marker, for example, that is invisible under normal conditions but can be rendered visible under certain conditions, such as under particular lighting conditions, which can be produced when the scanner 350 is operated.

FIG. 4 illustrates the second of these possibilities, where the step of acquiring the image comprises acquiring a master file associated with the decor disposed on the main surface 403 of a ceramic unit 400. The master file may be an image or other data upon which the decor disposed on the main surface is based. At step S1, the master file associated with the decor on the main surface 403 of the ceramic unit 400 may be acquired. In some variations, the master file may be determined and/or verified based upon one or more markers 320 present on the main surface 403.

Referring to step S2, a correction factor may be determined for the ceramic unit 400. The correction factor may account for deviations between the master file and the actual decor on the main surface 403, for example, which may result from firing of the ceramic material causing the ceramic material to shrink or contract such that the decor applied to the main surface of the ceramic material also shrinks or contracts. As shown in step S2, the ceramic unit 400, for example, the main surface 403 of the ceramic unit 400 may be scanner, via the operation of a scanner 350, to determine the correction factor, such as by determining the dimensions of various markings, features, spacings within the decor and comparing the measurements to the corresponding dimensions indicated by the master file. The correction factor may be applied to the master file, for example, to scale the master file or otherwise correct the master file such that the master file accurately corresponds to the decor on the main surface of the ceramic unit.

Additionally or alternatively, the color and/or tonality (e.g., color coordinates) present on the main surface may be detected by the scanner 350 compared to the colors and/or tonality indicated in the master file such that the colors and/or tonality indicated in the master file may be corrected or adjusted to match the colors and/or tonality present in the decor on the main surface 403 of the ceramic unit 400.

### FIGS. 5 and 6

FIGS. 5 and 6 illustrate an embodiment of the step of deriving decor for the side of the ceramic unit, according to the third preferred embodiment. FIG. 5 illustrates an image 500 of the decor 104 disposed on the main surface 103 of a ceramic unit, illustrated with respect to a ceramic unit. As illustrated in FIG. 5, the decor 104 may include one or more features 510, for instance, a particular grain pattern within a wood-look decor or a particular vein or combination of veins within a stone-look decor, preferably, a marble decor.

In a third preferred embodiment, the step of deriving decor for a side of the ceramic unit from the image 500 comprises identifying a first portion 502 of the image 500 corresponding to a portion of the ceramic unit that will be used, for instance, installed, in an end-application. The step of deriving decor for a side of the ceramic unit from the image 500 also comprises identifying a second portion 504 of the image 500 corresponding to a portion of the ceramic unit adjacent to the portion of the ceramic unit that will be used. For example, the second portion 504 of the image 500 may be adjacent to the first portion 502 of the image 500 along a cut-line 505 (e.g., a line along which the ceramic unit will be cut). As also shown, the second portion 504 of the image 500 may be adjacent to the first portion 502 of the image 500 at the side that is to be provided with the decor.

As shown in FIG. 6, in the third preferred embodiment, the decor for the side 105 is based upon the second portion 504 of the image 500 of FIG. 5. For example, the decor for the side 105 may be the decor in the second portion 504 of the image 500 or, alternatively, the decor for the side 105 may comprise a portion of the decor in the second portion 504 of the image 500, or an adjustment, skewing, or other alteration of the decor in the second portion 504 of the image 500. As shown in FIGS. 5 and 6, because significant features within the first portion 502 of the image may extend into the second portion 504 of the image 500 (for instance, the features 510, which may represent patterns or veins), the use of the second portion 504 of the image 500 as the basis for the decor for the side 105 allows for the continuity of such features (for example, features 510, such as a vein or pattern) between the decor on the main surface 103 and the side 105.

### FIG. 7

FIG. 7 illustrates an embodiment of the step of deriving decor for the side of the ceramic unit, according to the second preferred embodiment. FIG. 7 illustrates an image 700 of the decor 104 disposed on the main surface 103 of a ceramic unit, illustrated with respect to a ceramic unit. In FIG. 7, and as similarly discussed with respect to FIG. 5, the decor 104 may include one or more features 510, for instance, a particular grain pattern within a wood-look decor or a particular vein or combination of veins within a stone-look decor.

In the second preferred embodiment, the step of deriving decor for a side of the ceramic unit from the image comprises evaluating the image 700 and, also, determining the decor for the side based upon the evaluation of the image. Preferably, the step of evaluating the image 700 is performed via a suitable machine-learning model. For instance, the machine-learning model may be configured to identify one or more features 510 within the image 700 (and/or within a first portion of image) corresponding to a feature within the decor 104 on the main surface 103.

Also, preferably, the step of determining the decor for the side based upon the evaluation of the image 700 is also performed via the machine-learning model. For example, the machine-learning model may also be configured to predict a related feature 712 based upon the feature 510 identified within the image 700. In the second preferred embodiment, because the machine-learning model can identify certain features within the decor on the main surface 103 and predict corresponding or related features 712 within the decor 704 on the side, the use of the machine-learning model allows for continuity of features (for example, feature 510, such as a vein or pattern) between the decor on the main surface 103 and the side 105.

### FIG. 8—Computing System

A machine-learning model suitable for deriving decor for the side of the ceramic unit from the image is illustrated in the context of FIG. 8. For example, FIG. 8 illustrates an embodiment of a computing system 800 that includes a number of clients 805, a server system 815, and a data repository 840 communicably coupled through a network 810 by one or more communication links 802 (e.g., wireless, wired, or a combination thereof). The clients 805, generally, can include any hardware or software device that accesses a service made available by the server system 815. For instance, the scanner 350 of FIGS. 3 and 4 and/or a computing device communicatively coupled with the scanner 350 may be a client, such that the scanner 350 is able to send and receive information (e.g., digital images) with the computing system 800. The computing system 800, generally, can execute applications and analyze data associated with images, for example, an image of decor present on the main surface of a ceramic, such as may be acquired in the performance of the methods disclosed herein. For instance, the computing system 800 may execute a machine-learning model 835 to evaluate the image and, also, determine the decor for the side based upon the evaluation of the image.

In general, the server system 815 can be any server that stores one or more hosted applications, such as, for example, the machine-learning model 835. In some instances, the machine-learning model 835 may be executed via requests and responses sent to users or clients within and communicably coupled to the illustrated computing system 800. In some instances, the server system 815 may store a plurality of various hosted applications, while in other instances, the server system 815 may be a dedicated server meant to store and execute only a single hosted application, such as the machine-learning model 835.

In some instances, the server system 815 may comprise a web server, where the hosted applications represent one or more web-based applications accessed and executed via network 810 by the clients 805 of the system to perform the programmed tasks or operations of the hosted application. At a high level, the server system 815 can comprise an electronic computing device operable to receive, transmit, process, store, or manage data and information associated with the computing system 800. Specifically, the server system 815 illustrated in FIG. 8 can be responsible for receiving application requests from one or more client applications associated with the clients 805 of computing system 800 and responding to the received requests by processing the requests in the associated hosted application and sending the appropriate response from the hosted application back to the requesting client application.

In addition to requests from the clients 805, requests associated with the hosted applications may also be sent from internal users, external or third-party customers, other automated applications, as well as any other appropriate entities, individuals, systems, or computers. As used in the present disclosure and as described in more detail herein, the term “computer” is intended to encompass any suitable processing device. For example, although FIG. 8 illustrates a single server system 815, a computing system 800 can be implemented using two or more server systems 815, as well as computers other than servers, including a server pool. The server system 815 may be any computer or processing device such as, for example, a blade server, general-purpose personal computer (PC), Macintosh, workstation, UNIX-based workstation, or any other suitable device. In other words, the present disclosure contemplates computers other than general-purpose computers, as well as computers without conventional operating systems. Further, the illustrated server system 815 may be adapted to execute any operating system, including Linux, UNIX, Windows, Mac OS, or any other suitable operating system.

In the illustrated embodiment, and as shown in FIG. 8, the server system 815 includes a processor 820, an interface 830, a memory 825, and the machine-learning model 835. The interface 830 is used by the server system 815 for communicating with other systems in a client-server or other distributed environment (including within computing system 800) connected to the network 810 (e.g., clients 805, as well as other systems communicably coupled to the network 810). Generally, the interface 830 comprises logic encoded in software and/or hardware in a suitable combination and operable to communicate with the network 810. More specifically, the interface 830 may comprise software supporting one or more communication protocols associated with communications such that the network 810 or interface's hardware is operable to communicate physical signals within and outside of the illustrated computing system 800.

Although illustrated as a single processor 820 in FIG. 8, two or more processors may be used according to particular needs, desires, or particular embodiments of computing system 800. Each processor 820 may be a central processing unit (CPU), a blade, an application-specific integrated circuit (ASIC), a field-programmable gate array (FPGA), or another suitable component. Generally, the processor 820 executes instructions and manipulates data to perform the operations of server system 815 and, specifically, the machine-learning model 835. Specifically, the server's processor 820 executes the functionality required to receive and respond to requests from the clients 805 and their respective client applications, as well as the functionality required to perform the other operations of the machine-learning model 835.

Regardless of the particular implementation, “software” may include computer-readable instructions, firmware, wired or programmed hardware, or any combination thereof on a tangible medium operable when executed to perform at least the processes and operations described herein. Each software component may be fully or partially written or described in any appropriate computer language including C, C++, C #, Java, Visual Basic, assembler, Perl, any suitable version of 4GL, as well as others. It will be understood that while portions of the software implemented in the context of the embodiments disclosed herein may be shown as individual modules that implement the various features and functionality through various objects, methods, or other processes, the software may instead include a number of sub-modules, third-party services, components, libraries, and such, as appropriate. Conversely, the features and functionality of various components can be combined into single components as appropriate. In the illustrated computing system 800, processor 820 executes one or more hosted applications on the server system 815.

At a high level, the machine-learning model 835 is any application, program, module, process, or other software that may execute, change, delete, generate, or otherwise manage information according to the present disclosure, particularly in response to and in connection with one or more requests received from the illustrated clients 805 and their associated client applications. In certain cases, only one machine-learning model 835 may be located at a particular server system 815. In others, a plurality of related and/or unrelated modeling systems may be stored at a server system 815, or located across a plurality of other server systems 815, as well. In certain cases, computing system 800 may implement a composite hosted application. For example, portions of the composite application may be implemented as Enterprise Java Beans (EJBs) or design-time components may have the ability to generate run-time implementations into different platforms, such as J2EE (Java 2 Platform, Enterprise Edition), ABAP (Advanced Business Application Programming) objects, or Microsoft's .NET, among others. Additionally, the hosted applications may represent web-based applications accessed and executed by clients 805 or client applications via the network 810 (e.g., through the Internet).

Further, while illustrated as internal to server system 815, one or more processes associated with machine-learning model 835 may be stored, referenced, or executed remotely. For example, a portion of the machine-learning model 835 may be a web service associated with the application that is remotely called, while another portion of the machine-learning model 835 may be an interface object or agent bundled for processing at a client 805 located remotely. Moreover, any or all of the machine-learning model 835 may be a child or sub-module of another software module or enterprise application (not illustrated) without departing from the scope of this disclosure. Still further, portions of the machine-learning model 835 may be executed by a user working directly at server system 815, as well as remotely at clients 805.

The server system 815 also includes memory 825. Memory 825 may include any memory or database module and may take the form of volatile or non-volatile memory. The illustrated computing system 800 of FIG. 8 also includes one or more clients 805. Each client 805 may be any computing device operable to connect to or communicate with at least the server system 815 and/or via the network 810 using a wireline or wireless connection.

The illustrated data repository 840 may be any database or data store operable to store data, such as data one or more images associated with one or more ceramic units and/or data associated with decor, such as various design schemes or patterns. Generally, the data may comprise inputs to the machine-learning model 835, historical and/or operational information associated with one or more ceramic units and/or data associated with the surface ornamentation associated with the natural materials that various ceramic units are intended to imitate (e.g., such as various design schemes or patterns), and output data from the machine-learning model 835.

The functionality of one or more of the components disclosed with respect to FIG. 8, such as the server system 815 or the clients 805, can be carried out on a computer or other device comprising a processor (e.g., a desktop computer, a laptop computer, a tablet, a server, a smartphone, or some combination thereof). Generally, such a computer or other computing device may include a processor (which may be referred to as a central processor unit or CPU) that is in communication with memory devices including secondary storage, read-only memory (ROM), random access memory (RAM), input/output (I/O) devices, and network connectivity devices. The processor may be implemented as one or more CPU chips.

### FIG. 9—Machine-Learning Model

FIG. 9 depicts an example of the operation of the machine-learning model 835 of FIG. 8. In the embodiment of FIG. 9, the machine-learning model 835 comprises a machine-learning module 950 coupled to one or more data stores, for example, data within the data repository 840. For instance, in the embodiment of FIG. 9, the data within the data repository 840 of FIG. 8 may include data from a training data store 920 and/or inputs 930.

As also shown in FIG. 9, the machine-learning module 950 can access data, such as data from the training data store 920, receive inputs 930, and provide an output 960 based upon the inputs 930 and data retrieved from the training data store 920. Generally, the machine-learning module 950 utilizes data stored in the training data store 920 pertaining to the surface ornamentation associated with natural materials that various ceramic units are intended to imitate to enable the machine-learning module 950 to predictively derive decor for a side of a ceramic unit associated with an image evaluated by the machine-learning module 950. In various embodiments as will be disclosed herein, the data stored in the training data store 920 may generally include data pertaining to the surface ornamentation associated with natural materials that various ceramic units are intended to imitate.

In some embodiments, at least a portion of the information in the training data store 920 can be used to train or develop the machine-learning module 950 to predictively derive decor for a side of a ceramic unit associated with an image evaluated by the machine-learning module 950. For example, at least a portion of the data stored in the training data store 920 may be characterized as “training data” that is used to train the machine-learning module 950. As will be appreciated by the ordinarily-skilled artisan upon viewing the instant disclosure, although FIG. 8 illustrates an embodiment in which the training data are stored in a single “store” (e.g., at least a portion of the training data store 920), additionally or alternatively, in some embodiments the training data may be stored in multiple stores in one or more locations. Additionally, in some embodiments, the training data (e.g., at least a portion of the data stored in the training data store 920) may be subdivided into two or more subgroups, for example, a training data subset, one or more evaluation and/or testing data subsets, or combinations thereof.

In various embodiments, the training data may include various types of image data related the surface ornamentation associated with the natural materials that various ceramic units are intended to imitate. For example, in various embodiments, the image data can include images derived from various substrates, for example, naturally-occurring substrates of the type that a ceramic unit (e.g., a ceramic slab or ceramic tile) is intended to imitate. For instance, the image data can include images of one or more surfaces of natural stone materials, such as granite or marble, or various species of wood. Alternatively, the image data can include images of one or more surfaces of materials imitating such naturally-occurring materials. The image data can include images from a main surface and one or more corresponding sides of the same substrate.

As also shown in the embodiment of FIG. 9, the machine-learning module 950 can receive one or more inputs 930. Generally, the inputs 930 can comprise one or more constraints or limitations that may affect the way in which the machine-learning module 950 is trained. In various embodiments, the inputs 930 can be provided as separate inputs, as a single input, or as a vector or matrix of input values. In some embodiments, the inputs 930 may be received, for example, from an equipment operator or other user. In various embodiments, the inputs 930 may define, for instance, constraints or parameters for the machine-learning module 950.

Generally, the machine-learning module 950 is a learning machine exhibiting “artificial intelligence” capabilities. For example, the machine-learning module 950 may utilize algorithms to learn via inductive inference based on observing data that represents incomplete information about statistical phenomenon and generalizes it to rules and to make predictions on missing attributes or future data. Further, the machine-learning module 950 may perform pattern recognition, in which the machine-learning module 950 “learns” to automatically recognize complex patterns, to distinguish between exemplars based upon varying patterns, and to make intelligent predictions. In some embodiments, the machine-learning module 950 can perform optimization to narrow down the data used to allow the machine-learning module 950 to operate efficiently, even when large amounts of historical training data are present, and/or when complex input parameters are present.

The machine-learning module 950 can comprise and/or implement any suitable machine-learning algorithm or methodology, examples of which may include, but are not limited to, artificial neural networks (ANNs), deep neural networks (DNNs), deep reinforcement learning, convolutional neural networks, decision trees, support vector machines, Bayesian networks, genetic algorithms, and the like, and combinations thereof.

At a high level, the machine-learning module 950 may receive inputs 930 comprising constraints, parameters, and training data, for example, data from the training data store 920 to perform learning with respect to the surface ornamentation associated with the natural materials that various ceramic units are intended to imitate. For example, in some embodiments, the machine-learning module 950 may “learn” or be trained by processing the training data, more particularly, the data from the training data store 920, which includes a plurality of batches of data, each batch representing each of a data for each of a plurality of scenarios. Each batch of data may include known inputs (e.g., the surface ornamentation on a first surface, for example, corresponding to the main surface) and a known outcome (e.g., the surface ornamentation on a second surface, for example, corresponding to a side). As the machine-learning module 950 processes the training data, the machine-learning module 950 may form one or more probability-weighted associations between the various known inputs and the respective outcomes. As training progresses, the machine-learning module 950 may adjust weighted associations between various inputs, for example, according to a learning rule, in order to decrease the error between the inputs and their respective outputs. As such, the machine-learning module 950 may increasingly approach a target output until the error is acceptable.

As such, in some embodiments, based on processing the training data, for example, data from the training data store 920, the machine-learning module 950 may provide, as an output 960, a prediction of decor for a surface for instance a side. That is, once the machine-learning module 950 has been trained using the training data, the machine-learning module 950 may be used to evaluate the image and, also, determine the decor for the side based upon the evaluation of the image.

In some embodiments, the trained machine-learning module 950 may undergo one or more evaluation, validation, and/or or testing protocols to determine whether or not the trained machine-learning module exhibits sufficient ability to predict decor. For example, the trained machine-learning module may be evaluated and/or tested using at least a portion of the training data (e.g., an evaluation data subset). During the evaluation procedure, the trained machine-learning module may process evaluation data and the results of the evaluation may be compared to an acceptable error threshold. If the error exhibited by the trained machine-learning module is not acceptable, the machine-learning module may be retrained. In various embodiments, the trained, and optionally retrained, machine-learning module may be subjected to any desired number of evaluations, testing, and or verification stages. When the error exhibited by the trained machine-learning module is acceptable error across the desired number of evaluations, testing, and or verification stages, the machine-learning model may be considered ready for use.

### FIGS. 10 and 11

FIGS. 10 and 11 illustrate an embodiment of the step of deriving decor for the side of the ceramic unit, according to the third preferred embodiment. FIG. 10 illustrates an image 500 of the decor 104 disposed on the main surface 103 of a ceramic unit, illustrated with respect to a ceramic unit. As illustrated in FIG. 10, the decor 104 may include one or more features 510, for instance, a particular grain pattern within a wood-look decor or a particular vein or combination of veins within a stone-look decor, preferably, a marble decor, as similarly discussed with respect to other embodiments.

In the third preferred embodiment, the step of deriving decor for a side of the ceramic unit from the image comprises identifying a first portion 502 of the image 500 corresponding to a portion of the ceramic unit that will be used, for instance, installed, in an end-application. The step of deriving decor for a side of the ceramic unit from the image 500 also comprises identifying at least a part 1004 of the first portion of the image 500 corresponding to a portion of the ceramic along the side at which the decor is to be provided. For example, the part 1004 of the first portion 502 of the image 500 may be adjacent to the side that will be formed upon cutting, for example, along a cut-line 505 (e.g., a line along which the ceramic unit will be cut).

As shown in FIG. 11, in the third preferred embodiment, the decor for the side 105 is based upon the part 1004 of the first portion 502 of the image 500. For example, the decor for the side 105 may be a mirror-image 1006 the decor in the part 1004 of the first portion 502 of the image 500, for instance, mirrored along the cut-line 505 or, alternatively, the decor for the side 105 may comprise a portion of the decor in the part 1004 of the first portion 502 of the image 500 (e.g., mirrored along the cutting line), or an adjustment, skewing, or other alteration of a mirror-image of the decor in the part 1004 of the first portion 502 of the image 500. As shown in FIGS. 10 and 11, because the decor is the mirror-image 1006 of the decor along the side (e.g., cut-line 505) at which the decor is to be provided, the use of the decor within the part 1004 of the first portion 502 of the image as the basis for the decor for the side allows for the continuity of such features (e.g., a vein or pattern) between the decor on the main surface 103 and the side 105.

### FIG. 12

FIG. 12 illustrates some steps of the method for manufacturing a ceramic unit, such as the ceramic unit 100 of FIGS. 1 and 2. The ceramic unit 100 is provided on top of a transporter T in a first step S1 of providing the ceramic unit 100. The transporter T, for example transporting belt, moves the ceramic unit 100 in an advancing direction A. It is to be noted that the ceramic unit 100 provided at the first step S1 comprises the glazed decor 104 on the main surface 103 and has a side 105 (e.g., a side resulting from having been cut) that is free from any glaze or coating so that the ceramic material 102 is exposed at the side 105. The ceramic unit 100 can be obtained by cutting a ceramic unit into pieces and then rectifying the edges to create the side 105. The cutting and rectifying step, although not illustrated, can form part of the method of the disclosed subject matter. Since the cutting and/or rectifying steps can be performed with the aid of lubricant in a wet process they can be followed by a drying step.

The ceramic unit 100 is transported to a drying station 1209 preferably provided with an IR lamp 1210, for drying at least the side 105 of the ceramic unit 100 in a drying step S2. In the drying step S2 it is ensured that the side 105 is completely dry at the time of performing the subsequent steps. In fact, it is to be noted that the porosity of the ceramic material 102 can absorb moisture present in the atmosphere thereby negatively affecting the adhesion between the ink and the ceramic material. This drying step S2 is further drying step than those performed after any cutting step.

The dried ceramic unit 100 is then transported to a printing station 1211 provided with a printer 1212 for the step S3 of providing the decorative layer 107 to yield the decor 106 onto the side 105, by inkjet printing a radiation-curable ink directly onto the ceramic material 102. In fact, FIG. 12 illustrates that there is not any material application step on the side 105 before the printing step S3. The set of curable inks may preferably comprise acrylic based inks, for example comprising of acrylate oligomers and/or monomers such as polyester acrylate, polyether acrylate, urethane acrylate, epoxy acrylate, or combinations thereof. Although FIG. 12 illustrates inkjet printing with curable inks, other suitable inks may be used, as disclosed herein.

### FIG. 13

FIG. 13 schematically shows a detail of the printer 1212. The printer 1212 is a single pass printer that comprises a plurality of printing units 1213, each printing unit comprises one or more printing head, and is configured to print only one color. In a single pass printer 1212 the printing units are stationary and the ceramic unit 100 moves of a continuous movement below the printing units 1213 that disperse the drops of ink while the ceramic unit 100 moves.

In the example shown in FIG. 13, the printing units 1213 may comprise a printing head having a plurality of nozzles of, for instance, a 60 micrometer (um) diameter, and configured for ejecting droplets of 12 picoliters (pl) or more and, preferably, to print a quantity of ink between 0.75 to 1.15 mg/square cm. In some embodiments, the printing may be effective to form a layer that is sufficiently thick to show good adhesion performances and mechanical, physical, and chemical properties. Moreover, the decor may be printed with a resolution of 360 dpi.

The example shown in FIG. 13, illustrates an embodiment in which the printer is configured to print a CMYK set of ink, and therefore comprises a CMYK set of printing units 1215, and it is configured to print a set of extra ink, for instance, white and yellow ink, and comprise an extra set of printing units 1214. In particular, the extra set of printing units 1214 is disposed upstream the CMYK set of printing units 1215 with respect to the advancing direction, so that the extra inks are printed first. In this way, the extra ink printed on the side 105 can form a background for the CMYK inks, thereby help in developing the colors of the decor 106.

In alternative embodiments, the printer 1212 can be configured to print only the CMYK inks and not the extra ink. This depends on the decor 106 to be printed and may be the case when the decor 106 has darker color that the color of the ceramic material of the base body, for example a dark wood decor on a white or grey porcelain. In this case the printer 1212 can be free from the extra set of printing unit 1214.

Returning to FIG. 12, the printed ceramic unit 100 is carried to a first curing station 1216 provided with an UV lamp 1217, such as a LED-UVA lamp, for curing the decorative layer 107 in a first curing step S4.

After curing the decorative layer 107, the ceramic unit 100 is carried to a coating station 1218 comprising a roller coater 1219 that performs a step S5 of providing the protective coat 108 on top of the decorative layer 107. The protective coat 108 is preferably transparent or translucent and is preferably acrylic based. The protective coat 108 can be provided in form of a suspension comprising the uncured protective coat composition and filler or additives, like mineral particles.

The ceramic unit 100, is subsequently transported to a second curing station 1220 provided with an UV lamp 1221, for instance, a Mercury UVB lamp, for curing the protective coat 108 in a second curing step S6.

### FIG. 14

FIG. 14 shows an additional or alternative method for manufacturing the ceramic unit 100. The method of FIG. 14 has the same steps of the method of FIG. 12, and further comprises a step S7 of providing a sealant to at least partially filling the open porosity of the ceramic material at least in correspondence of the side. In the example, the ceramic unit 100, after drying step S2 is carried to a sealing station 1222 comprising an application device 1223, for example, a drier or a roller applicator for performing the sealing step S7. Preferably the sealant can comprise polymer, oligomer, monomer or blends thereof that are epoxy based, siloxane based unsaturated polyester based or polyvinyl base or a mixture thereof.

The sealant preferably is a curable substance, more preferably a heat-curable substance, in particular organic substance. Thus, the method further comprises the step S8 of curing, drying the sealant. This sealant curing step S8 may be performed in a third curing station 1224 having a drying chamber 1225. As shown in FIG. 14, sealing steps S7 and S8 are performed upstream to the printing step S3. The drying step S2 is preferably performed upstream than the sealing steps S7 and S8, anyway it is not excluded that the drying step S2, is performed downstream or both upstream and downstream to the sealing steps S7 and S8.

### ADDITIONAL ASPECTS

The disclosure having been generally described, the following examples are given as particular aspects of the disclosure and to demonstrate the practice and advantages thereof. It is understood that the examples are given by way of illustration and are not intended to limit the specification or the claims in any manner.

Aspect 1 is a method for providing one or more sides or edges of a ceramic unit with decor, the method comprising providing the ceramic unit, the ceramic unit being made of a ceramic material and comprising decor disposed on a main surface of the ceramic unit; acquiring an image of at least a portion of the decor disposed on the main surface of the ceramic unit; deriving decor for a side of the ceramic unit from the image; providing the decor on the side of the ceramic unit.

Aspect 2 is the method of aspect 1, wherein the ceramic unit is a ceramic slab.

Aspect 3 is the method of aspect 2, wherein the ceramic slab has a length and/or a width of at least 90 cm, preferably from about 120 cm to about 320 cm, and a thickness from about 5 mm to about 20 mm, preferably from about 6 mm to about 12 mm.

Aspect 4 is the method of aspect 1, wherein the ceramic unit is a ceramic tile.

Aspect 5 is the method of aspect 4, wherein the ceramic tile has a length and/or width from about 2 cm to about 90 cm and a thickness from about 2 mm to about 20 mm, preferably from about 6 mm to about 12 mm.

Aspect 6 is the method of one of aspects 1 through 5, wherein the ceramic material is characterized as exhibiting a water absorption less than 0.5%, as measured according to EN ISO 10545, preferably, as exhibiting a water absorption less than 0.1%, as measured according to EN ISO 10545.

Aspect 7 is the method of one of aspects 1 through 6, wherein the ceramic material is classified, according to EN 14411, in Group BIa, preferably, as a porcelain material.

Aspect 8 is the method of one of aspects 1 through 7, wherein the step of acquiring the image comprises scanning at least a portion of the decor disposed on the main surface.

Aspect 9 is the method of one of aspects 1 through 8, wherein the step of acquiring the image comprises acquiring a master file associated with the decor disposed on the main surface, wherein the master file comprises data upon which the decor disposed on the main surface is based and/or data upon which the decor disposed on the side surface is based.

Aspect 10 is the method of aspect 9, wherein the step of acquiring the image comprises evaluating the ceramic unit, for example scanning at least a portion of the decor disposed on the main surface and/or measuring the dimension of the ceramic unit and/or the color coordinates of the at least a portion of the decor disposed on the main surface, deriving at least one correction factor from said evaluation, and correcting the master file based on said correction factor.

Aspect 11 is the method of one of aspects 1 through 10, wherein the step of deriving decor for a side of the ceramic unit from the image comprises identifying a first portion of the image corresponding to a portion of the ceramic unit that will be used; and identifying a second portion of the image corresponding to a portion of the ceramic unit adjacent to the portion of the ceramic unit that will be used.

Aspect 12 is the method of aspect 11, wherein the first portion and the second portion of the image each comprise a portion of an image feature that is continuous between the first portion and the second portion.

Aspect 13 is the method of one of aspects 11 through 12, wherein the decor for the side is based upon the second portion of the image.

Aspect 14 is the method of one of aspects 1, wherein the step of deriving decor for a side of the ceramic unit from the image comprises evaluating the image; and determining the decor for the side based upon the evaluation of the image.

Aspect 15 is the method of aspect 14, wherein the step of evaluating the image and the step of determining the decor for the side based upon the evaluation of the image is performed by a machine-learning model.

Aspect 16 is the method of aspect 15, wherein the machine-learning model is configured to identify a feature within the image corresponding to a feature within the decor on the main surface.

Aspect 17 is the method of aspect 16, wherein the machine-learning model is configured to predict a related feature based upon the feature identified within the image.

Aspect 18 is the method of one of aspects 1 through 17, wherein the step of deriving decor for the side of the ceramic unit from the image comprises identifying a first portion of the image corresponding to a portion of the ceramic unit that will be used; and identifying at least a part of the first portion of the image corresponding to a portion of the ceramic along the side.

Aspect 19 is the method of aspect 18, wherein the decor for the side is a mirror-image the decor in the part of the first portion of the image or a portion, an adjustment, a skewing, or another alteration thereof.

Aspect 20 is the method of one of aspects 1 through 19, wherein the step of providing the decor comprises printing with an inkjet printer.

Aspect 21 is the method of aspect 20, wherein the step of printing the inkjet printer comprises jetting droplets of 12 picoliters (pl).

Aspect 22 is the method of one of aspects 1 through 21, wherein the step of providing the decor comprises printing, by an inkjet printer, with a curable ink; and curing the curable ink.

Aspect 23 is the method of one of aspects 22, wherein the step of providing the decor on the side by inkjet printing the curable ink is a single pass printing operation.

Aspect 24 is the method of one of aspects 22 through 23, wherein the step of curing the curable ink comprises UV or UV LED curing.

Aspect 25 is the method of aspect 24, wherein the step of curing involves using a gallium, mercury lamp or a LED-UV lamp.

Aspect 26 is the method of one of aspects 22 through 25, wherein the curable ink is an acrylate-based ink.

Aspect 27 is the method of one of aspects 22 through 26, the curable ink comprises a white ink or a yellow ink.

Aspect 28 is the method of one of aspects 22 through 27, wherein the step of providing the decor comprises printing a background color and printing the decor.

Aspect 29 is the method of aspect 28, wherein curing the curable ink comprises curing the background color and curing the decor in the same step.

Aspect 30 is the method of one of aspects 28 through 29, wherein printing the background color and printing the decor are performed with the same printer.

Aspect 31 is the method of one of aspects 1 through 30, wherein the step of providing the decor comprises printing with a CMYK set of colors.

Aspect 32 is the method of one of aspects 1 through 31, wherein the step of providing the decor comprises printing with a CMYK set of inks and a set of extra ink.

Aspect 33 is the method of one of aspects 1 through 32, further comprising providing a protective coat on top of the decor.

Aspect 34 is the method of aspect 33, wherein the protective coat is a curable protective coat.

Aspect 35 is the method of one of aspects 34, further comprising curing the protective coating.

Aspect 36 is the method of one of aspects 33 through 35, wherein the protective coating comprises a flattening agent or mineral particles.

Aspect 37 is the method of one of aspects 33 through 36, wherein the protective coat comprises a thickness greater than the thickness of the decor.

Aspect 38 is the method of one of aspects 33 through 37, wherein the step of providing the protective coat is an inkjet printing step.

Aspect 39 is the method of one of aspects 1 through 38, wherein the step of providing the decor on the side further comprises drying the side before printing.

Aspect 40 is the method of aspect 39, wherein the drying step removes air moisture from the ceramic material.

Aspect 41 is the method of one of aspects 1 through 40, wherein the step of providing the decor is performed via a printhead having nozzle of 60 micrometer (μm) diameter.

Aspect 42 is the method of one of aspects 1 through 41, wherein the decor comprises a thickness between 6 to 25 μm.

Aspect 43 is the method of one of aspects 1 through 42, wherein the decor is printed with a resolution of 360 dpi.

Aspect 44 is the method of one of aspects 1 through 43, wherein the decor is provided in a quantity of 0.75 to 1.15 mg/square cm.

Aspect 45 is a ceramic unit obtained by the method according to any of the preceding claims.

Aspect 46 is a machine-learning model, wherein the machine-learning model is configured to receive an image of at least a portion of decor disposed on a main surface of a ceramic unit; evaluate the image; and determine the decor for a side of the ceramic unit based upon the evaluation of the image.

Aspect 47 is the machine-learning model of aspect 46, wherein the machine-learning model is configured to identify a feature within the image corresponding to a feature within the decor on the main surface.

Aspect 48 is the machine-learning model of aspect 47, wherein the machine-learning model is configured to predict a related feature based upon the feature identified within the image.

Aspect 49 is a method of training a machine-learning model configured to receive an image of at least a portion of the decor disposed on the main surface of a ceramic unit, to evaluate the image and, to determine the decor for a side of the ceramic unit based upon the evaluation of the image, the method comprising processing training data.

Aspect 50 is the method of aspect 49, wherein image data is related to surface ornamentation associated with a natural material, preferably, stone or wood, more preferably, granite or marble.

Aspect 51 is the method of one of aspects 49 through 50, further comprising evaluating the machine-learning model to determine if an error exhibited by the trained machine-learning module is not acceptable.

Aspect 52 is a ceramic unit comprising a ceramic material having a main surface with decor and a side having a decor that is inkjet-printed, wherein the decor on the side exhibits a high degree of continuity with respect to the main surface, for example the side having design features that appear to be continuous between the main surface and the side; and/or the decor on the side comprises cured ink.

Aspect 53 is the ceramic unit of aspect 52, wherein said decor of the side is derived from the decor on the main surface.

Aspect 54 is the ceramic unit of one of aspects 52 through 53, wherein the decor for the side comprises a portion of the decor in a part of the main surface, or an adjustment, a skewing, or another alteration thereof.

Aspect 55 is the ceramic unit of one of aspects 52 through 54, wherein said decor of the side is a mirror-image of a portion of the decor on the main surface, or a portion, an adjustment, a skewing, or another alteration thereof.

Aspect 56 is the ceramic unit of one of aspects 52 through 55, wherein the ceramic unit is a ceramic slab.

Aspect 57 is the ceramic unit of aspect 56, wherein the ceramic slab has a length and/or a width of at least 90 cm, preferably from about 120 cm to about 320 cm, and a thickness from about 5 mm to about 20 mm, preferably from about 6 mm to about 12 mm.

Aspect 58 is the ceramic unit of one of aspects 52 through 55, wherein the ceramic unit is a ceramic tile.

Aspect 59 is the ceramic unit of aspect 58, wherein the ceramic tile has a length and/or width from about 2 cm to about 90 cm and a thickness from about 2 mm to about 20 mm, preferably from about 6 mm to about 12 mm.

Aspect 60 is the ceramic unit of one of aspects 52 through 59, wherein the ceramic material is characterized as exhibiting a water absorption less than 0.5%, as measured according to EN ISO 10545, preferably, as exhibiting a water absorption less than 0.1%, as measured according to EN ISO 10545.

Aspect 61 is the ceramic unit of one of aspects 52 through 60, wherein the ceramic material is classified, according to EN 14411, in Group BIa, preferably, as a porcelain material.

Aspect 62 is the ceramic unit of one of aspects 52 through 61, wherein the decor is printed with an inkjet printer.

Aspect 63 is the ceramic unit of aspect 62, wherein the decor is printed with droplets of 12 picoliters (pl).

Aspect 64 is the ceramic unit of one of aspects 52 through 63, wherein the decor is printed with a curable ink.

Aspect 65 is the ceramic unit of aspect 64, wherein the curable ink comprises a UV curable ink.

Aspect 66 is the ceramic unit of one of aspects 64 through 65, wherein the curable ink is an acrylate-based ink.

Aspect 67 is the ceramic unit of one of aspects 64 through 66, the curable ink comprises a white ink or a yellow ink.

Aspect 68 is the ceramic unit of one of aspects 64 through 67, wherein the decor comprises a background color.

Aspect 69 is the ceramic unit of one of aspects 52 through 68, wherein the decor is printed with a CMYK set of colors.

Aspect 70 is the ceramic unit of one of aspects 52 through 69, wherein the decor is printed with a CMYK set of inks and a set of extra ink.

Aspect 71 is the ceramic unit of one of aspects 52, further comprising a protective coat on top of the decor.

Aspect 72 is the ceramic unit of aspect 71, wherein the protective coat is a curable protective coat.

Aspect 73 is the ceramic unit of one of aspects 71 through 72, wherein the protective coating comprises a flattening agent or mineral particles.

Aspect 74 is the ceramic unit of one of aspects 71 through 73, wherein the protective coat comprises a thickness greater than the thickness of the decor.

Aspect 75 is the ceramic unit of one of aspects 52 through 74, wherein the decor comprises a thickness between 6 to 25 μm.

Aspect 76 is the ceramic unit of one of aspects 52 through 75, wherein the decor is printed with a resolution of 360 dpi.

Aspect 77 is the ceramic unit of one of aspects 52 through 76, wherein the decor is provided in a quantity of 0.75 to 1.15 mg/square cm.

Aspect 78 is a set of ceramic units comprising at least a first ceramic unit and a second ceramic unit each having a respective decor on its main surface, wherein the first ceramic unit comprises a decor on at least one side and wherein the decor on the side of the first ceramic unit is based on at least a portion of the decor on the main surface of the second ceramic unit.

Aspect 79 is the set of ceramic units of aspect 78, wherein the decor of the side comprises a portion of the decor on the main surface of the second surface, or an adjustment, a skewing, or another alteration thereof.

Aspect 80 is the set of ceramic units of one of aspects 78 through 79, wherein the decor of the side is a mirror-image of a portion of the decor on the main surface of the second surface, or an adjustment, a skewing, or another alteration thereof.

Aspect 81 is the set of ceramic units of one of aspects 78 through 80, wherein at least a part of the decor on the main surface of the first ceramic unit comprise at least a part of the decor on the main surface of the second ceramic unit.

Aspect 82 is the set of ceramic units of one of aspects 78 through 81, wherein the ceramic unit is a ceramic slab.

Aspect 83 is the set of ceramic units of aspect 82, wherein the ceramic slab has a length and/or a width of at least 90 cm, preferably from about 120 cm to about 320 cm, and a thickness from about 5 mm to about 20 mm, preferably from about 6 mm to about 12 mm.

Aspect 84 is the set of ceramic units of one of aspects 78 through 81, wherein the ceramic unit is a ceramic tile.

Aspect 85 is the set of ceramic units of aspect 84, wherein the ceramic tile has a length and/or width from about 2 cm to about 90 cm and a thickness from about 2 mm to about 20 mm, preferably from about 6 mm to about 12 mm.

Aspect 86 is the set of ceramic units of one of aspects 78 through 85, wherein the first ceramic unit comprises a ceramic material, wherein the ceramic material is characterized as exhibiting a water absorption less than 0.5%, as measured according to EN ISO 10545, preferably, as exhibiting a water absorption less than 0.1%, as measured according to EN ISO 10545.

Aspect 87 is the set of ceramic units of one of aspects 78 through 86, wherein the first ceramic unit comprises a ceramic material, wherein the ceramic material is classified, according to EN 14411, in Group BIa, preferably, as a porcelain material.

Aspect 88 is the set of ceramic units of one of aspects 78 through 87, wherein the decor on the side is printed with an inkjet printer.

Aspect 89 is the set of ceramic units of aspect 88, wherein the decor on the side is printed with droplets of 12 picoliters (pl).

Aspect 90 is the set of ceramic units of one of aspects 78 through 89, wherein the decor on the side is printed with a curable ink.

Aspect 91 is the set of ceramic units of aspect 90, wherein the curable ink comprises a UV curable ink.

Aspect 92 is the set of ceramic units of one of aspects 90 through 91, wherein the curable ink is an acrylate-based ink.

Aspect 93 is the set of ceramic units of one of aspects 90 through 92, the curable ink comprises a white ink or a yellow ink.

Aspect 94 is the set of ceramic units of one of aspects 90 through 93, wherein the decor on the side comprises a background color.

Aspect 95 is the set of ceramic units of one of aspects 78 through 94, wherein the decor on the side is printed with a CMYK set of colors.

Aspect 96 is the set of ceramic units of one of aspects 78 through 95, wherein the decor on the side is printed with a CMYK set of inks and a set of extra ink.

Aspect 97 is the set of ceramic units of one of aspects 78 through 96, further comprising a protective coat on top of the decor on the side.

Aspect 98 is the set of ceramic units of aspect 97, wherein the protective coat is a curable protective coat.

Aspect 99 is the set of ceramic units of aspect 98, wherein the protective coating comprises a flattening agent or mineral particles.

Aspect 100 is the set of ceramic units of one of aspects 97 through 99, wherein the protective coat comprises a thickness greater than the thickness of the decor.

Aspect 101 is the set of ceramic units of one of aspects 78 through 100, wherein the decor on the side comprises a thickness between 6 to 25 μm.

Aspect 102 is the set of ceramic units of one of aspects 78 through 101, wherein the decor on the side is printed with a resolution of 360 dpi.

Aspect 103 is the set of ceramic units of one of aspects 78 through 102, wherein the decor on the side is provided in a quantity of 0.75 to 1.15 mg/square cm.

Aspect 104 is a method for providing one or more sides or edges of a ceramic unit with decor, the method comprising providing the ceramic unit, the ceramic unit being made of a ceramic material and comprising decor disposed on a main surface of the ceramic unit; acquiring a first master file associated with the decor to be printed on said side; evaluating the ceramic unit, for example scanning at least a portion of the decor disposed on the main surface and/or measuring the dimension of the ceramic unit and/or the color coordinates of the at least a portion of the decor disposed on the main surface; deriving at least one correction factor from said evaluation; correcting the master file on the basis of said correction factor; and providing the decor on the side of the ceramic unit based on the corrected master file.

Aspect 105 is the method of aspect 104, wherein the ceramic unit is a ceramic slab.

Aspect 106 is the method of aspect 105, wherein the ceramic slab has a length and/or a width of at least 90 cm, preferably from about 120 cm to about 320 cm, and a thickness from about 5 mm to about 20 mm, preferably from about 6 mm to about 12 mm.

Aspect 107 is the method of aspect 104, wherein the ceramic unit is a ceramic tile.

Aspect 108 is the method of aspect 107, wherein the ceramic tile has a length and/or width from about 2 cm to about 90 cm and a thickness from about 2 mm to about 20 mm, preferably from about 6 mm to about 12 mm.

Aspect 109 is the method of one of aspects 104 through 108, wherein the ceramic material is characterized as exhibiting a water absorption less than 0.5%, as measured according to EN ISO 10545, preferably, as exhibiting a water absorption less than 0.1%, as measured according to EN ISO 10545.

Aspect 110 is the method of one of aspects 104, wherein the ceramic material is classified, according to EN 14411, in Group BIa, preferably, as a porcelain material.

Aspect 111 is the method of one of aspects 104 through 110, wherein the step of providing the decor comprises printing with an inkjet printer.

Aspect 112 is the method of aspect 111, wherein the step of printing the inkjet printer comprises jetting droplets of 12 picoliters (pl).

Aspect 113 is the method of one of aspects 104 through 112, wherein the step of providing the decor comprises printing, by an inkjet printer, with a curable ink; and curing the curable ink.

Aspect 114 is the method of aspect 113, wherein the step of providing the decor on the side by inkjet printing the curable ink is a single pass printing operation.

Aspect 115 is the method of one of aspects 113 through 114, wherein the step of curing the curable ink comprises UV or UV LED curing.

Aspect 116 is the method of aspect 115, wherein the step of curing involves using a gallium, mercury lamp or a LED-UV lamp.

Aspect 117 is the method of one of aspects 113 through 116, wherein the curable ink is an acrylate-based ink.

Aspect 118 is the method of one of aspects 113 through 117, the curable ink comprises a white ink or a yellow ink.

Aspect 119 is the method of one of aspects 113 through 118, wherein the step of providing the decor comprises printing a background color and printing the decor.

Aspect 120 is the method of aspect 119, wherein curing the curable ink comprises curing the background color and curing the decor in the same step.

Aspect 121 is the method of one of aspects 119 through 120, wherein printing the background color and printing the decor are performed with the same printer.

Aspect 122 is the method of one of aspects 104 through 121, wherein the step of providing the decor comprises printing with a CMYK set of colors.

Aspect 123 is the method of one of aspects 104 through 122, wherein the step of providing the decor comprises printing with a CMYK set of inks and a set of extra ink.

Aspect 124 is the method of one of aspects 104 through 123, further comprising providing a protective coat on top of the decor on the side.

Aspect 125 is the method of one of aspects 124, wherein the protective coat is a curable protective coat.

Aspect 126 is the method of aspect 125, further comprising curing the protective coating.

Aspect 127 is the method of one of aspects 124 through 126, wherein the protective coating comprises a flattening agent or mineral particles.

Aspect 128 is the method of one of aspects 124 through 127, wherein the protective coat comprises a thickness greater than the thickness of the decor.

Aspect 129 is the method of one of aspects 124 through 128, wherein the step of providing the protective coat is an inkjet printing step.

Aspect 130 is the method of one of aspects 104 through 134, wherein the step of providing the decor on the side further comprises drying the side before printing.

Aspect 131 is the method of aspect 130, wherein the drying step removes air moisture from the ceramic material.

Aspect 132 is the method of one of aspects 104 through 131, wherein the step of providing the decor is performed via a printhead having nozzle of 60 micrometer (μm) diameter.

Aspect 133 is the method of one of aspects 104 through 132, wherein the decor on the side comprises a thickness between 6 to 25 μm.

Aspect 134 is the method of one of aspects 104 through 133, wherein the decor on the side is printed with a resolution of 360 dpi.

Aspect 135 is the method of one of aspects 104 through 134, wherein the decor on the side is provided in a quantity of 0.75 to 1.15 mg/square cm.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rl, and an upper limit, Ru, is disclosed, any number falling within the range is specifically disclosed. In particular, the following numbers within the range are specifically disclosed: R=R1+k*(Ru−Rl), wherein k is a variable ranging from 1 percent to 100 percent with a 1 percent increment, i.e., k is 1 percent, 2 percent, 3 percent, 4 percent, 5 percent, . . . , 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the presently disclosed subject matter.

1-20. (canceled)

21. A method for providing one or more sides or edges of a ceramic unit with decor, the method comprising:
providing the ceramic unit, the ceramic unit being made of a ceramic material and comprising decor disposed on a main surface of the ceramic unit;
acquiring an image of at least a portion of the decor disposed on the main surface of the ceramic unit;
deriving decor for a side of the ceramic unit from the image;
providing the decor on the side of the ceramic unit.

22. The method of claim 21, wherein the ceramic unit is a ceramic slab, for example having a length and/or a width of at least 90 cm, preferably from about 120 cm to about 320 cm, and a thickness from about 5 mm to about 20 mm, preferably from about 6 mm to about 12 mm.

23. The method according to claim 21, wherein the step of acquiring the image comprises scanning at least a portion of the decor disposed on the main surface.

24. The method according to claim 21, wherein the step of acquiring the image comprises acquiring a master file associated with the decor disposed on the main surface, wherein the master file comprises data upon which the decor disposed on the main surface is based and/or data upon which the decor disposed on the side surface is based.

25. The method of claim 24, wherein the step of acquiring the image comprises evaluating the ceramic unit, for example scanning at least a portion of the decor disposed on the main surface and/or measuring the dimension of the ceramic unit and/or the color coordinates of the at least a portion of the decor disposed on the main surface, deriving at least one correction factor from said evaluation, correcting the master file based on said correction factor.

26. The method according to claim 21, wherein the step of deriving decor for a side of the ceramic unit from the image comprises:
identifying a first portion of the image corresponding to a portion of the ceramic unit that will be used; and
identifying a second portion of the image corresponding to a portion of the ceramic unit adjacent to the portion of the ceramic unit that will be used.

27. The method of claim 26, wherein the first portion and the second portion of the image each comprise a portion of an image feature that is continuous between the first portion and the second portion.

28. The method of claim 26, wherein the decor for the side is based upon the second portion of the image.

29. The method according to claim 21, wherein the step of deriving decor for a side of the ceramic unit from the image comprises:
evaluating the image; and
determining the décor for the side based upon the evaluation of the image.

30. The method of claim 29, wherein the step of evaluating the image and the step of determining the decor for the side based upon the evaluation of the image is performed by a machine-learning model.

31. The method of claim 30, wherein the machine-learning model is configured to identify a feature within the image corresponding to a feature within the decor on the main surface.

32. The method of claim 30, wherein the machine-learning model is configured to predict a related feature based upon the feature identified within the image.

33. The method according to claim 21, wherein the step of deriving decor for the side of the ceramic unit from the image comprises:
identifying a first portion of the image corresponding to a portion of the ceramic unit that will be used; and
identifying at least a part of the first portion of the image corresponding to a portion of the ceramic along the side.

34. The method of claim 33, wherein the decor for the side is a mirror-image the decor in the part of the first portion of the image or a portion, an adjustment, a skewing, or another alteration thereof.

35. The method according to claim 21, wherein the step of providing the decor on the side comprises printing with an inkjet printer.

36. The method according to claim 21, wherein the step of providing the decor on the side comprises:
printing, by an inkjet printer, with a curable ink; and
curing the curable ink.

37. A ceramic unit comprising a ceramic material having a main surface with decor and a side having a décor that is inkjet-printed, wherein:
the decor on the side exhibits a high degree of continuity with respect to the decor on the main surface, for example the side having design features that appear to be continuous between the main surface and the side; and/or
the decor on the side comprises cured ink; and preferably wherein:
said decor of the side is derived from the décor on the main surface; and/or
the decor for the side comprises a portion of the decor in a part of the main surface, or an adjustment, a skewing, or another alteration thereof;
said decor of the side is a mirror-image of a portion of the decor on the main surface, or a portion, an adjustment, a skewing, or another alteration thereof.

38. The ceramic unit of claim 37, wherein the ceramic unit is a ceramic slab.

39. A set of ceramic units comprising at least a first ceramic unit and a second ceramic unit each having a respective decor on its main surface, wherein the first ceramic unit comprises a decor on at least one side and wherein the decor on the side of the first ceramic unit is based on at least a portion of the decor on the main surface of the second ceramic unit; preferably wherein:
the decor of the side comprises a portion of the decor on the main surface of the second surface, or an adjustment, a skewing, or another alteration thereof; and/or
the decor of the side is a mirror-image of a portion of the decor on the main surface of the second surface, or an adjustment, a skewing, or another alteration thereof; and/or
at least a part of the decor on the main surface of the first ceramic unit comprise at least a part of the decor on the main surface of the second ceramic unit.

40. The set of ceramic units of claim 39, wherein the ceramic unit is a ceramic slab.
